(19) United States
(12) Patent Application Publication
(10) Pub. No.: US 2016/0000243 A1
(43) Pub. Date: Jan. 7, 2016

(54) THERMOFORMED ARTICLES FROM POLYPROPYLENE POLYMER COMPOSITIONS

(71) Applicant: INTERNATIONAL PAPER COMPANY, Memphis, TN (US)

(72) Inventor: Richard A. Tedford, JR., Loveland, OH (US)

(21) Appl. No.: 14/733,091

(22) Filed: Jun. 8, 2015

Related U.S. Application Data
(60) Provisional application No. 62/020,492, filed on Jul. 3, 2014.

(51) Int. Cl. A47G 19/22; B29C 51/10

(52) U.S. Cl. CPC A47G 19/2205; B29C 51/10; B29K 2023/14

(57) ABSTRACT

Thermoformed fluid material container closures, such as reclosable dome-shaped beverage lids, having an inner “plug fit” securement groove for removably securing the fluid material container closure to an upper rim of a beverage cup and which have a drip rate of about 1 g or less per 20 seconds. These closures such as beverage lids are made by a thermoforming process from a thermoformable web (e.g., sheet) to provide a generally dome-shaped upper fluid material-dispensing portion from polypropylene polymers having a flexural modulus of at least about 230,000 kpsi and in which a fluid-dispensing orifice in formed in the fluid material-dispensing portion which is substantially aligned with the machine direction (MD) of the thermoformable web.

### CROSS-REFERENCE TO RELATED APPLICATIONS

This application makes reference to and claims the benefit of the following co-pending U.S. Provisional Patent Application No. 62/020,492, filed Jul. 3, 2014. The entire disclosure and contents of the foregoing Provisional Application is hereby incorporated by reference.

### FIELD OF THE INVENTION

The present invention broadly relates to thermoformed articles comprising polypropylene polymer compositions in the form of closures for fluid material containers (e.g., beverage sip lids) having a generally dome-shaped upper fluid material-dispensing portion. The present invention further relates to a thermoforming process for preparing such articles from thermoformable webs (e.g., sheets) comprising polypropylene polymer compositions.

### BACKGROUND

Thermoformable formulations such as sheets, etc., have been prepared from various thermoplastic polymers such as polystyrene polymers. Such thermoformable polymers have found use in the preparation of numerous articles such as containers, toys, appliance components, etc. In preparing thermoformed articles from such polymers, the unused portion of the thermoformable formulation (e.g., the trimmed flashing, scrap, etc.) may also be recycled several times, with or without virgin thermoformable material, in such thermoforming processes. For reasons of recyclability, resin cost, and other issues, alternatives to polystyrene polymers have been sought for preparing thermoformed articles.

Articles prepared from such thermoformable formulations may include closures for fluid material-dispensing containers, such as disposable beverage sip lids for disposable beverage cups. To provide such articles, the thermoformable formulation may be initially extruded as a continuous thermoplastic sheet. This continuous thermoplastic sheet may then be heated in, for example, an oven to make the thermoplastic sheet sufficiently pliable for subsequent thermoforming. This heated thermoplastic sheet may then be advanced to a thermoforming unit having a mold (or plurality of such molds) to form, for example, shaped articles (e.g., a plurality of disposable beverage sip lids) in a thermoformed section of the thermoplastic sheet corresponding to the dimensions of the thermoforming mold(s). These shaped articles created in the thermoformed section of the thermoplastic sheet may then be detached (e.g., cut out) from the remaining unshaped portion of the thermoformed section using, for example, a trim press.

### SUMMARY

According to a first broad aspect of the present invention, there is provided an article in the form of a thermoformed fluid material container closure, the fluid material container closure comprising:
a lower container-securing portion having an inner plug fit securement groove for removably securing the fluid material container closure to an upper rim of a fluid material container; and
an upper generally dome-shaped fluid material-dispensing portion extending generally upwardly from the lower container-securing portion and having a fluid material-dispensing orifice formed therein;
wherein the fluid material container closure comprises a polypropylene polymer composition which includes from about 50 to 100% polypropylene polymer having a flexural modulus of at least about 230,000 kpsi;
wherein the fluid material container closure has a wall thickness in the range of from about 10 to about 30 mils;
wherein when the fluid material container closure is removably secured to the upper rim of the fluid material container, the removably secured fluid material container closure provides a drip rate of about 1 gram or less per 20 seconds.

According to a second broad aspect of the present invention, there is provided an article in the form of a thermoformed reclosable beverage sip lid, the reclosable beverage sip lid comprising:
a lower generally annular cup rim-securing portion having an inner plug fit annular securement groove for removably securing the fluid material container closure to an upper rim of a beverage cup; and
an upper generally frustoconical-shaped beverage-dispensing portion extending generally upwardly from the lower portion and having a beverage-dispensing sip hole formed therein;
wherein the reclosable beverage sip lid comprises a polypropylene polymer composition which includes from about 50 to 100% polypropylene polymer having a flexural modulus of at least about 230,000 kpsi;
wherein the reclosable beverage sip lid has a wall thickness in the range of from about 10 to about 30 mills;
wherein when the reclosable beverage sip lid is removably secured to the upper lip of the beverage cup, the reclosable beverage lid provides a drip rate of about 1 gram or less per 20 seconds.

According to a third broad aspect of the present invention, there is provided a process for preparing a thermoformed fluid material container closure which comprises the following steps of:
(a) providing a thermoformable web having comprising from about 50 to 100% polypropylene polymer having a flexural modulus of at least about 230,000 kpsi and having a machine direction (MD) and a cross machine direction (CD) orthogonal to the machine direction (MD) with a web width in the range of from about 20 to about 55 inches in the cross machine direction (CD);
(b) thermoforming the thermoformable web of step (a) with a fluid material closure-forming mold having a lower fluid material container-securing forming mold section which forms an inner plug fit securement groove and a generally dome-shaped upper fluid material-dispensing forming mold section extending generally upwardly from the lower mold section to provide a thermoformed fluid material container closure having a lower container-securing portion having formed therein the inner plug fit securement groove for removably securing the fluid material container closure to an upper rim of a fluid material container and a generally dome-shaped upper fluid material-dispensing portion extending generally upwardly from the lower container-securing portion; and
(c) forming in the upper fluid material-dispensing portion of the thermoformed fluid material container closure step (b) a fluid dispensing orifice which is substantially aligned with the machine direction (MD) of the thermoformable web;
wherein the thermoformed article fluid material container closure of step (c) has:
   a wall thickness in the range of from about 10 to about 30 mils;
   when removably secured to the upper rim of the fluid material container, a drip rate of about 1 gram or less per 20 seconds.

According to a fourth broad aspect of the present invention, there is provided a process for preparing a thermoformed reclosable beverage lid, which comprise the following steps of:
(a) providing a thermoformable sheet comprising from about 50 to 100% polypropylene polymer having a flexural modulus of at least about 230,000 kpsi and having a machine direction (MD) and a cross machine direction (CD) orthogonal to the machine direction (MD) with a width of in the range of from about 20 to about 55 inches in the cross machine direction (CD)];
(b) thermoforming the thermoformable sheet of step (b) with a reclosable beverage sip lid forming mold having a generally annular lower cup rim-securing portion forming mold section which forms an inner a plug fit annular securement groove and an upper generally frustoconical-shaped beverage-dispensing portion forming mold section extending generally upwardly from the lower mold section to provide a thermoformed reclosable beverage lid having a lower generally annular cup lip-securing portion having formed therein the inner plug fit annular securement groove for removably securing the beverage sip lid to an upper lip of a beverage cup and an upper generally frustoconical-shaped beverage-dispensing portion extending generally upwardly from the lower cup lip-securing portion; and
(c) forming a beverage-dispensing sip hole in the upper beverage-dispensing portion of the thermoformed reclosable beverage sip lid of step (b) which is substantially aligned with the machine direction (MD) of the thermoformable sheet;
wherein the thermoformed reclosable beverage sip lid of step (c) has:
   a wall thickness in the range of from about 10 to about 30 mils;
   when removably secured to the upper lip of the beverage cup, a drip rate of about 1 gram or less per 20 seconds.

### BRIEF DESCRIPTION OF THE DRAWINGS

The invention will be described in conjunction with the accompanying drawings, in which:

FIG. 1 is a schematic diagram illustrating an embodiment of a process for preparing a thermoformed article (e.g., beverage sip lid) from a thermoformable web (e.g., sheet) comprising polypropylene polymer composition according to the present invention;

FIG. 2 is a perspective view of an embodiment of a dome-shaped male mold which may be used in thermoforming dome-shaped beverage lids using an “interference fit” type securement for a beverage cup;

FIG. 3 is a perspective view of an embodiment of a dome-shaped beverage lid-forming male mold which may be used in thermoforming dome-shaped beverage lids using a “plug fit” type securement for a beverage cup;

FIG. 4 is a top plan view of the “interference fit” type securement beverage lid formed by the mold of FIG. 2;

FIG. 5 is a top plan view of the “plug fit” type securement beverage lid formed by the mold of FIG. 3;

FIG. 6 is a bottom plan view of the interference fit” type securement beverage lid of FIG. 4;

FIG. 7 is a bottom plan view of the “plug fit” type securement beverage lid of FIG. 5;

FIG. 8 is a centerline sectional view of the interference fit” type securement beverage lid of FIG. 4 taken along line 8-8, and including the upper portion of a beverage cup with parts broken away to which the beverage lid may be reclosably secured;

FIG. 9 is a centerline sectional view of the “plug fit” type securement beverage lid of FIG. 5 taken along line 9-9, and including the upper portion of a beverage cup with parts broken away to which the beverage lid may be reclosably secured;

FIG. 10 is a cut away top plan view of a portion of a beverage lid sheet formed according to the thermoforming step of the process of FIG. 1 illustrating an orientation of the sipper holes of the respective thermoformed beverage sip lids at the 3 o'clock position relative to the direction of advancement/travel/movement, etc., of the sheet;

FIG. 11 is a cut away top plan view of a portion of a beverage lid sheet formed according to the thermoforming step of the process of FIG. 1 illustrating an orientation of the sipper holes of the respective thermoformed beverage sip lids at the 9 o'clock position relative the direction of advancement/travel/movement, etc., of the sheet;

FIG. 12 is a cut away top plan view of a portion of a beverage lid sheet formed according to the thermoforming step of the process of FIG. 1 illustrating an orientation of the sipper holes of the thermoformed beverage sip respective lids at the 6 o'clock position relative to the direction of advancement/travel/movement, etc., of the sheet; and

FIG. 13 is a cut away top plan view of a portion of a beverage lid sheet formed according to the thermoforming step of the process of FIG. 1 illustrating an orientation of the sipper holes of the respective thermoformed beverage sip lids at the 12 o'clock position relative to the direction of advancement/travel/movement, etc., of the sheet.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provides below, unless specifically indicated.

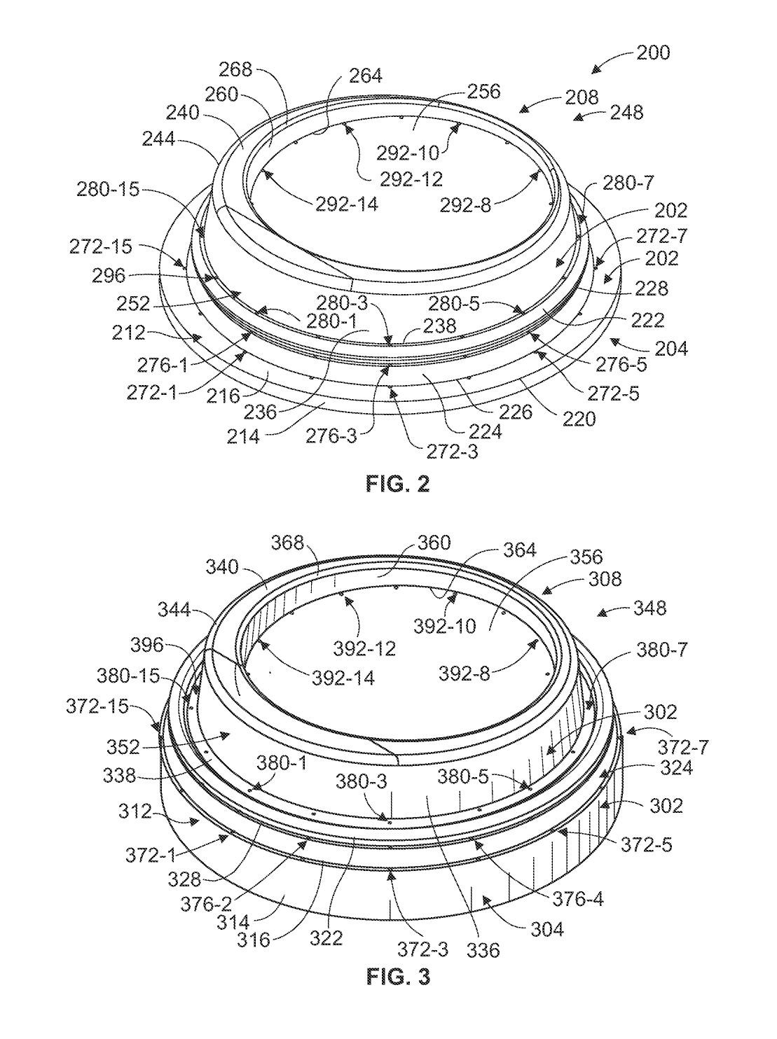

For the purposes of the present invention, directional or positional terms such as “top,” “bottom,” “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” etc., are merely used for convenience in describing the various embodiments of the present invention. For example, the orientation of the embodiments shown in FIGS. 2-13 may be reversed or flipped over, rotated by 90° in any direction, etc.

For the purposes of the present invention, the term “polypropylene polymer composition” refers to a thermoformable polymer blend comprising at least: one or more polypropylene polymers; and optionally one or more other additives such as colorants, nucleating agents, mineral fillers, etc.

For the purposes of the present invention, the term “polypropylene polymer” (also known as polypropene) refers to semi-crystalline thermoplastic polymers comprising propylene units. Polypropylene polymer resins may be available as homopolymers, copolymers, random copolymers, etc., having differing amounts of atactic and isotactic isomers. Polypropylene polymers may also be in the form of isotactic, syndiotatic, or atactic isomers, as well as mixtures of such isomers. Isotactic polypropylene may have a melting in the range of, for example, from about 320° to about 340° F. depending upon the amount of isotactic isomer present. Polypropylene polymers may also be in the form of homopolymers, or copolymers with, for example, ethylene, and may also exist in α, β, or γ crystalline forms. Suitable polypropylene polymers may have a flexural modulus of, for example, at least about 230,000 kpsi, such as from about 230,000 to about 350,000 kpsi (e.g., from about 250,000 to about 300,000 kpsi). Suitable commercially available polypropylene polymers may include one or more of: LyondellBasell (LB) Adstif HA802b; Flint Hills 21N2A; Braskem Inspire 6201; etc.

For the purposes of the present invention, the term “polypropylene polymer nucleating agent” refers to a composition, compound, etc., which induces the formation of either α or β polymer crystals (i.e., causes crystallinity to occur) in a polypropylene polymer composition. Alpha-phase nucleating agents may be included in polypropylene polymer compositions to increase the clarity of the thermoformed article (i.e., make the thermoformed article more clear in appearance) by inducing a larger number of α-phase polypropylene crystals which grow to a smaller size so that clarity is not reduced, to increase the flexural modulus of the thermoformed article, etc., and may be added in any amount effective to induce such α-phase crystal effects, for example, in amounts of from 0 to about 10% by weight (such as from about 1 to about 3% by weight) of the polypropylene polymer composition Suitable α-phase polypropylene polymer crystal inducing nucleating agents may include one or more of: inorganic compounds such as talc, silica, kaolin, etc.; dibenzylidene sorbitol (DBS) or its C₁-C₈-alkyl-substituted derivatives such as methyldibenzylidenesorbitol, ethyldibenzylidenesorbitol, dimethyldibenzylidenesorbitol, etc.; organphosphate salts, such as salts of diesters of phosphoric acid, e.g., sodium 2,2′-methylenebis(4,6-di-tertbutylphenyl)phosphate or aluminium-hydroxy-bis[2,2′-methylene-bis(4,6-di-tbutylphenyl)phosphate; salts of monocarboxylic or polycarboxylic acids, e.g., sodium benzoate or aluminum tertbutylbenzoate; nonitol derivatives like 1,2,3-trideoxy-4,6:5,7-bis-O[(4-propylphenyl)methylene]-nonitol; vinylcycloalkane polymers, vinylalkane polymers, etc. norbornane carboxylic acid salts (e.g., Hyperform HPN-68); etc. See, for example, U.S. Pat. No. 8,946,326 (Kulshreshtha et al.), issued Feb. 2, 2015, the entire disclosure and contents of which are herein incorporated by reference. By contrast, β-phase nucleating agents may be added to such polypropylene polymer composition so as to permit thermoforming of the web at lower temperatures, etc. and may be added in any amount effective to induce such β-phase crystal formation effects, for example, in amounts of from about 0.5 to about 10% by weight (such as from about 1 to about 3% by weight) of the polypropylene polymer composition. Suitable β-phase polypropylene polymer crystal inducing nucleating agents may include one or more of: quinacridones such as the γ-crystalline form of a quinacridone colorant Permanent Red E3B (hereafter referred to as “Q-dye”) having the structural formula shown at column 4, lines 40-49 of U.S. Pat. No. 7,407,699 (Jacoby), issued Aug. 5, 2008; the bisodium salt of o-phthalic acid; the aluminum salt of 6-quinizarin sulfonic acid; isophthalic acid; terephthalic acid; certain amide compounds such as N′,N′-dicyclohexyl-2,6-naphthalene dicarboxamide (also known as NJ Star NU-100, developed by the New Japan Chemical Co; tetraoxaspiro compounds; iron oxide having a nano-scale size; alkali or alkaline earth metal salts of carboxylic acids, such as potassium 1,2-hydroxystearate, magnesium benzoate, magnesium succinate, magnesium phthalate, etc.; aromatic sulfonic acid compounds such as sodium benzenesulfonate, sodium naphthalenesulfonate, etc.; di- or triesters of dibasic or tribasic carboxylic acids; phthalocyanine series pigments such as phthalocyanine blue; two-component-based compounds composed of an organic dibasic acid and an oxide, hydroxide or a salt of a Group HA metal; a composition composed of a cyclic phosphorus compound and a magnesium compound; a two component (A component and B component) β nucleating agent prepared from (A) an organic dibasic acid, such as pimelic acid, azelaic acid, o-phthalic acid, terephthalic acid, and isophthalic acid, and (B) an oxide, hydroxide or an acid salt of a Group II metal such as magnesium, calcium, strontium, and barium, wherein the acid salt of the B component may be derived from an organic or inorganic acid, such as a carbonate, stearate, etc.; etc. See, for example, U.S. Pat. No. 8,968,863 (Brown et al.), issued Mar. 3, 2015; U.S. Pat. No. 8,680,169 (Yamada et al.), issued Mar. 25, 2014; U.S. Pat. No. 7,407,699 (Jacoby), issued Aug. 5, 2008; U.S. Pat. No. 5,231,126 (Shi et al.), issued Jul. 27, 1993, the entire disclosure and contents of which are herein incorporated by reference, which disclose illustrative β crystal nucleating agents for polypropylene. Suitably commercially available β crystal nucleating agents for polypropylene may include one or more of: pelletized masterbatches of β crystal nucleating agent such as MPM® 2000, MPM® 1112, MPM® 1110, MPM® 1111, MPM® 1113, MPM® 1114, MPM® 1101, etc., produced by Mayzo Corporation. In some instances, the β crystal nucleating agent may be incorporated with a commercially available polypropylene resin, such as: “BEPOL B-022SP”, a polypropylene manufactured by Aristech, Inc.; “BETA (β)-PP BE60-7032”, a polypropylene manufactured by Borealis AG; “BNX BETAPP-LN”, a polypropylene manufactured by Mayzo, Inc.; etc. See, for example, U.S. Pat. No. 8,680,169 (Yamada et al.), issued Mar. 25, 2014, the entire disclosure and contents of which are herein incorporated by reference.

For the purposes of the present invention, the term “Ziegler-Natta catalysts” refers to heterogeneous or homogeneous catalysts which may polymerize terminal 1-alkenes, such as propylene. Ziegler-Natta catalysts which restrict polymerization of propylene to isotactic polypropylene may include certain solid (mostly supported) catalysts and certain types of metallocene catalysts. Suitable solid supported catalysts may use TiCl₄ as an active ingredient and MgCl₂ as a support, and may also contain certain organic modifiers, such as aromatic acid esters and diesters or ethers. These catalysts may be activated with special co-catalysts containing, for example, an organoaluminum compound such as Al(C₂H₅)₃ and the second type of a modifier, i.e., aromatic ethers. Suitable metallocene catalysts may include, for example, ethanediylbridged bis(indenyl)titanium and bis(indenyl)zirconium complexes, together with methylalumoxane as an activator.

For the purposes of the present invention, the term “virgin polymer feedstock components” refers to polymer components used to form polypropylene polymer compositions which have not been previously recycled from, for example, thermoformed material.

For the purposes of the present invention, the term “recycled polymer” refers to polymers, and materials comprising such polymers which have been recycled for inclusion (wholly or partially) in the polypropylene polymer composition.

For the purposes of the present invention, the term “regrind” refers to recycled trimmed polymer that has been reground for inclusion (wholly or partially) in the polypropylene polymer composition.

For the purposes of the present invention, the term “thermoforming” refers to a process for preparing a shaped, formed, etc., article (e.g., a container closure, such as a beverage lid) from a thermoformable web. In thermoforming, the thermoformable web may be heated to its melting or softening point, stretched over or into a temperature-controlled, single-surface mold and then held against the mold surface until cooled (solidified). The formed article may then be trimmed from the thermoformed web. The trimmed material may be reground, mixed with virgin polymer, and reprocessed into a usable thermoformable web. Thermoforming may include vacuum molding, pressure molding, plug-assist molding, vacuum snapback molding, etc., as well as variations of any of the foregoing thermoforming techniques.

For the purposes of the present invention, the term “thermoform” and similar terms such as, for example “thermoformed,” etc., refers to articles made by a thermoforming process.

For the purposes of the present invention, the term “thermoformable web” refers to a web comprising a polypropylene polymer composition which is ready for thermoforming into an article. A thermoformable web may be in the form of a continuous roll, a discrete sheet, etc., and may be formed by extrusion, etc. For example, a thermoformable web may be in the form of an extruded sheet, etc.

For the purposes of the present invention, the term “molding” refers to any thermoforming process for shaping, forming, etc., a pliable softened or melted thermoformable web using a mold device, mold tool, (e.g., a molding die).

For the purposes of the present invention, the term “vacuum molding” refers to a thermoforming process wherein a thermoformable web (e.g., a thermoplastic sheet) is heated to a forming temperature, is, for example, stretched onto a mold, for example, a convex (male) or a concave (female) single-surface mold, and forced against the male or female mold by a vacuum (e.g., by suction of air) to form the thermoformed article.

For the purposes of the present invention, the term “male mold” refers to a mold having a mold surface which has the same/similar shape as that of the finished molded article e.g., a container closure such as a beverage lid, but wherein the mold surface is against the interior surface of the molded article.

For the purposes of the present invention, the term “female mold” refers to a mold having a mold surface which has the same/similar shape as that of the finished molded article e.g., a container closure such as a beverage lid, but where the mold surface is inverted (relative to that of a male mold) such that mold surface is against the exterior surface of the molded article.

For the purposes of the present invention, the term “dome-shaped” refers to an upwardly raised convex shape extending generally in the vertical direction. As used herein, “dome-shaped” may include, for example, a frustoconical shape, a cylindrical shape, a semi-hemispherical shape, a rectangular-box shape, etc.

For the purposes of the present invention, the term “dome-shaped (container) closure” or “dome-shaped (beverage) lid” refers to a container closure (e.g., a beverage lid) having a dome-shaped upper fluid material (e.g., beverage)-dispensing portion, while the term “dome-shaped mold” refers to a mold used in thermoforming to provide such dome-shaped closures (e.g., a dome-shaped beverage lid).

For the purposes of the present invention, the term “container-securing portion” refers to the lower portion of a container closure (e.g., a beverage sip lid) which secures, mounts, attaches, joins, clips, snaps, fastens, connects, etc., the closure (e.g., beverage sip lid) on/to the upper rim portion of the container (e.g., the lip of a cup).

For the purposes of the present invention, the term “fluid material-dispensing portion” refers to the upper portion of a container closure which dispenses the fluid material (e.g., contains a fluid-dispensing orifice, aperture, opening, slit, slot, etc., such as a sip hole for dispensing a beverage).

For the purposes of the present invention, the term “fluid material-dispensing orifice location” refers to position where the fluid material-dispensing orifice (e.g., fluid-aperture, opening, slit, slot, hole, etc., such as a sip hole for dispensing a beverage) is located, or will be located when formed.

For the purposes of the present invention, the term “interference fit” refers to a securement groove type mechanism for attaching and securing closures (e.g., beverage sip lids) to containers (e.g., beverage cups) wherein an inner (annular) securement groove of the closure (e.g., beverage sip lid) snaps (potentially audibly) into place when pushed over the peripheral bead (rim or brim) around the lip of the container (cup) and wherein the primary mechanical contact force is directed radially from the securement groove toward the center of the cup and the cup rim/brim/lip provides the resistance to the force of the container/lid securement groove, i.e., the inner portion of the container/cup rim/brim/lip is not further supported by another portion of the container/lid to provide an additional “pinch” support on both the outer and inner sides/surfaces of the rim/brim/lip of the container/cup. This securement groove may also be formed with an annular apron or skirt adjacent to a base of the lid which, if sufficiently flexible, allows the annular apron/skirt containing the securement groove be able to momentarily expand while sliding over the bead surrounding the lip of the cup. When in place the annular groove grips the annular bead thereby holding and sealing the lid to the cup. The securement groove in interference fit lids may have a smaller diameter relative to that of the rim of the cup. For example, the difference in diameters may be in the range from about 1 to 60 mils, such as from about 20 to about 40 mils. Increasing the degree of interference of such lids with the rim of the cup reduces the drip rate but while also increasing the force that may be required to secure the lid to the cup.

For the purposes of the present invention, the term “plug fit” refers to a securement groove type mechanism for attaching and securing closures (e.g., beverage lids) to containers (e.g., beverage cups) wherein the closure (lid) has an inner, relatively deep (annular) groove for securing the closure (lid) to the container (cup). When this closure/lid with the relatively deep securement groove is attached to the container (cup), the rim/brim/lip of the container/cup extends into and is surrounded by this relatively deep securement groove which applies pressure not only to the upper outer edge of the container/cup, but also to the inner edge as well. By applying pressure to both edges of the container/cup, this “plug fit” securement groove minimizes, inhibits, prevents, etc., the rim/brim/lip of the container/cup lip caving inwardly, and thus causing a break in the seal between the closure (lid) and the rim/brim/lip of the container/cup.

For the purposes of the present invention, the term “extrusion” refers to a process for shaping, molding, forming, etc., a material by forcing, pressing, pushing, etc., the material through a shaping, forming, etc., device having an orifice, slit, etc., for example, a die, etc. Extrusion may be continuous (producing indefinitely long material such as a sheet, etc.) or semi-continuous (producing many short pieces, segments, etc.). Extrusion may be performed, for example, by single screw extruders (e.g., Brabender single screw extruder), twin-screw extruders (e.g., Leistritz co-rotating twin screw extruders, etc.), etc.

For the purposes of the present invention, the term “web forming die” refers to an extruder die which may be used to form a web (e.g., a sheet) of thermoplastic material. Suitable web forming dies may include flat type extrusion dies, coat-hanger type extrusion dies (having linear or curved die cavity configurations), etc. See, for example, U.S. Pat. No. 3,860,383 (Sirevicius), issued Jan. 14, 1975; U.S. Pat. No. 4,048,739, (Appel), issued Aug. 23, 1977; U.S. Pat. No. 4,285,655 (Matsubara), issued Aug. 25, 1981; U.S. Pat. No. 5,234,330 (Billows et al.), issued Aug. 10, 1993; U.S. Pat. No. 5,494,429 (Wilson et al.), issued Feb. 27, 1996; and U.S. Pat. No. 7,862,755 (Eligindi), issued Jan. 4, 2011, the entire disclosure and contents of which are herein incorporated by reference, which illustrate sheeting forming dies of the flat type extrusion die, coat-hanger type extrusion die (including having linear or curved die cavity configurations), etc.

For the purposes of the present invention, the term “web” refers to sheets, strips, films, pieces, segments, parisons, coupons, etc., which may be continuous in form (e.g., sheets, films, strips, etc.) for subsequent subdividing into discrete units, or which may be in the form of discrete units (e.g., pieces, pieces, segments, parisons, coupons, etc.).

For the purposes of the present invention, the term “amorphous” refers to a solid which is not crystalline, i.e., has no lattice structure which is characteristic of a crystalline state.

For the purposes of the present invention, the term “crystalline” refers to a solid which has a lattice structure which is characteristic of a crystalline state.

For the purposes of the present invention, the term “isotactic” refers to isomers of a polymer wherein the substituents (e.g., methyl groups in the case of a polypropylene polymer) are positioned on the same side relative to the polymer backbone.

For the purposes of the present invention, the term “syndiotactic” (also known as “syntactic”) refers to isomers of a polymer wherein the substituents (e.g., methyl groups in the case of polypropylene polymer) are positioned in a symmetrical and alternating fashion relative to the polymer backbone.

For the purposes of the present invention, the term “atactic” (refers to isomers of a polymer wherein the substituents (e.g., methyl groups in the case of polypropylene polymer) are positioned randomly relative to the polymer backbone.

For the purposes of the present invention, the term “melting point” refers to the temperature range at which a crystalline material changes state from a solid to a liquid, e.g., may be molten. While the melting point of material may be a specific temperature, it often refers to the melting of a crystalline material over a temperature range of, for example, a few degrees or less. At the melting point, the solid and liquid phases of the material often exist in equilibrium.

For the purposes of the present invention, the term “Tₘ” refers to the melting temperature of a material, for example, a polymer. The melting temperature is often a temperature range at which the material changes from a solid state to a liquid state. The melting temperature may be determined by using a differential scanning calorimeter (DSC) which determines the melting point by measuring the energy input needed to increase the temperature of a sample at a constant rate of temperature change, and wherein the point of maximum energy input determines the melting point of the material being evaluated.

For the purposes of the present invention, the term “softening point” refers to a temperature or range of temperatures at which a material is or becomes shapeable, moldable, formable, deformable, bendable, extrudable, pliable, etc. The term softening point may include, but does not necessarily include, the term melting point.

For the purposes of the present invention, the term “Tₛ” refers to the Vicat softening point (also known as the Vicat Hardness). The Vicat softening point is measured as the temperature at which a polymer specimen is penetrated to a depth of 1 mm by a flat-ended needle with a 1 sq. mm circular or square cross-section. A load of 9.81 N is used. Standards for measuring Vicat softening points for thermoplastic resins may include JIS K7206, ASTM D1525 or IS0306, which are incorporated by reference herein.

For the purposes of the present invention, the term “T_{g}” refers to the glass transition temperature. The glass transition temperature is the temperature: (a) below which the physical properties of amorphous materials vary in a manner similar to those of a solid phase (i.e., a glassy state); and (b) above which amorphous materials behave like liquids (i.e., a rubbery state).

For the purposes of the present invention, the term “heat deflection temperature (HDT)” or heat distortion temperature (HDTUL) (collectively referred to hereafter as the “heat distortion index (HDI)”) is the temperature at which a polymer deforms under a specified load. HDI is a measure of the resistance of the polymer to deformation by heat and is the temperature (in ° C.) at which deformation of a test sample of the polymer of predetermined size and shape occurs when subjected to a flexural load of a stated amount. HDI may be determined by following the test procedure outlined in ASTM D648, which is herein incorporated by reference. ASTM D648 is a test process which determines the temperature at which an arbitrary deformation occurs when test samples are subjected to a particular set of testing conditions. This test provides a measure of the temperature stability of a material, i.e., the temperature below which the material does not readily deform under a standard load condition. The test sample is loaded in three-point bending device in the edgewise direction. The outer fiber stress used for testing is 1.82 MPa, and the temperature is increased at 2° C./min until the test sample deflects 0.25 mm.

For the purposes of the present invention, the term “melt flow index (MFI)” (also known as the “melt flow rate (MFR)) refers to a measure of the ease of flow of the melt of a thermoplastic polymer, and may be used to determine the ability to process the polymer in thermoforming. MFI may be defined as the weight of polymer (in grams) flowing in 10 minutes through a capillary having a specific diameter and length by a pressure applied via prescribed alternative gravimetric weights for alternative prescribed temperatures. Standards for measuring MFI include ASTM D1238 and ISO 1133, which are herein incorporated by reference. The testing temperature used is 190° C. with a loading weight of 2.16 kg. For thermoforming according to embodiments of the present invention, the MFI of the polymers may be in the range from 0 to about 20 grams per 10 minutes, for example from 0 to about 15 grams per 10 minutes.

For the purposes of the present invention, the terms “viscoelasticity” and “elastic viscosity” refer interchangeably to a property of materials which exhibit both viscous and elastic characteristics when undergoing deformation. Viscous materials resist shear flow and strain linearly with time when a stress is applied, while elastic materials strain instantaneously when stretched and just as quickly return to their original state once the stress is removed. Viscoelastic materials have elements of both of these properties and, as such, exhibit time dependent strain. Whereas elasticity is usually the result of bond stretching along crystallographic planes in an ordered solid, viscoelasticity is the result of the diffusion of atoms or molecules inside of an amorphous material.

For the purposes of the present invention, the term “flexural modulus” (also known as “bending modulus”) refers to the ratio of stress to strain in flexural deformation, or the tendency for a material to bend and may be determined from the slope of a stress-strain curve produced by a flexural test (such as the ASTM D 790), and which uses units of force per area such as kpsi.

For the purposes of the present invention, the term “kpsi” refers to a unit of measure of flexural modulus equal to a thousand (1000) pounds per square inch (psi). One kpsi is also equal to ˜6895000 newtons/m².

For the purposes of the present invention, the term “colorant” refers to refers to compositions, compounds, substances, materials, etc., such as pigments, tints, etc., which causes a change in color of a substance, material, etc. In some embodiments, a mineral filler may also function as a colorant.

For the purposes of the present invention, the term “mineral filler” refers to inorganic materials, which may be in particulate form, which may lower cost (per weight) of the polypropylene polymer, may be used to increase to flexural modulus (e.g., stiffness) of the polypropylene polymer (especially at lower temperatures), may be used to affect shrinkage levels and rates of the resulting fluid material container closures (e.g., beverage lids), etc. Mineral fillers which may used in embodiments of the present invention may include, for example, talc, calcium chloride, titanium dioxide, clay, synthetic clay, gypsum, calcium carbonate, magnesium carbonate, calcium hydroxide, calcium aluminate, magnesium carbonate mica, silica, alumina, sand, gravel, sandstone, limestone, crushed rock, bauxite, granite, limestone, glass beads, aerogels, xerogels, fly ash, fumed silica, fused silica, tabular alumina, kaolin, microspheres, hollow glass spheres, porous ceramic spheres, ceramic materials, pozzolanic materials, zirconium compounds, xonotlite (a crystalline calcium silicate gel), lightweight expanded clays, perlite, vermiculite, hydrated or unhydrated hydraulic cement particles, pumice, zeolites, exfoliated rock, etc., and mixtures thereof. Mineral fillers may be present in amounts of, for example, up to about 40% by weight of the polypropylene polymer composition, such as from 0 to about 17% by weight of the polypropylene polymer composition (e.g., from 0 to about 10% by weight of the polypropylene polymer composition). While amounts of mineral filler above about 17% by weight the polypropylene polymer composition may be used in these polypropylene polymer composition, increasing the amount of mineral filler upwards above about 17% by weight may make fluid material container closures (e.g., beverage lids) comprising polypropylene polymer composition having such higher levels of mineral filler less buoyant, and thus less suitable for purposes of recycling in water-based recycling systems which depend upon the buoyancy of the material for separating recyclable from non-recyclable materials.

For the purposes of the present invention, the term “substantially homogeneous blend” refers to a blend of polypropylene polymer, plus any other optional components such as colorants, nucleating agents, mineral fillers, etc., which is substantially uniform in composition, texture, characteristics, properties, etc.

For the purposes of the present invention, the term “fluid material container” refers a container, receptacle, bottle, jug, urn, pot cup, etc., for fluid materials which may flowable solids such as granular solids, powders, etc., or which may be flowable liquids such as liquid beverages, liquid fuels, liquid lubricants, etc.

For the purposes of the present invention, the term “beverage” refers to aqueous liquid beverages such as coffee, chocolate beverages, tea beverages, other hot beverages, milk shakes, slushes, etc.

For the purposes of the present invention, the term “closure” refers to a component which functions as permanent or temporary closure, such as a lid, cap, cover, etc., for a fluid material container.

For the purposes of the present invention, the term “reclosable” refers to a closure, such as a lid, cap, cover, etc., which may be secured to, as well as unsecured from, a fluid material container.

For the purposes of the present invention, the term “drip rate” refers to the amount of fluid which drips within a period of 20 seconds when the container-securing portion of a fluid material container closure is removably secured to the upper rim of a fluid material container. Briefly, the drip rate test procedure involves filling the cup/container to within 0.75 inches of the rim/brim/lip thereof with 185° F. coffee. The closure/lid is then secured with the fluid material-dispensing orifice (e.g., sip hole) oriented (rotated) 180° away from the sideseam (if any) of the cup/container (which is where fluid dripping normally happens), with the container/cup being held horizontally with the sideseam down and with any drips of coffee being collected for weighing for 20 seconds. Orienting the fluid material-dispensing orifice/sip hole opposite the sideseam simplifies this test because no coffee may exit the container/cup via the fluid material-dispensing orifice/sip hole. See Drip Rate Measurement Technique described below.

For the purposes of the present invention, the term “thermoplastic” refers to the conventional meaning of thermoplastic, i.e., a composition, compound, material, etc., that exhibits the property of a material, such as a high polymer, that softens or melts to as to become pliable when exposed to sufficient heat and generally returns to its original condition when cooled to room temperature.

For the purposes of the present invention, the term “wall thickness” refers to the thickness of the material comprising the thermoformed container closure (e.g., beverage lid). Wall thickness is normally defined from the inner surface to the outer surface of the material comprising the thermoformed container closure and may normally correspond to the thickness of the thermoformable web (e.g., sheet) from which the thermoformed container closure is formed from.

For the purposes of the present invention, the term “mil(s)” is used in the conventional sense of referring to thousandths of an inch. The wall thickness of thermoformed articles, such as thermoformed container closures (e.g., beverage lids) are often referred to in terms of “gauge.” For example, a container closure having a “thin gauge” has a wall thickness of about 30 mils or less, such as from about 14 to about 24 mils.

For the purposes of the present invention, the term “MD” refers to machine direction of the sheet, i.e., is used in the conventional sense of the direction the web (sheet) is moved during its formation, processing, etc., and normally refers to a direction from the 6 o'clock to the 12 o'clock position.

For the purposes of the present invention, the term “CD” refers to the cross-machine direction, i.e., is used in the conventional sense of the direction transverse and orthogonal to the machine direction (MD) during formation, processing, etc., of a web (sheet), and normally refers to a direction from the 3 o'clock to the 9 o'clock, or from the 9 o'clock to the 3 o'clock position.

For the purposes of the present invention, the term “web width” refers to the width of the thermoformable/thermoformed web (e.g., sheet) in the cross-machine (CD) direction.

For the purposes of the present invention, the term “comprising” means various compounds, components, polymers, ingredients, substances, materials, layers, steps, etc., may be conjointly employed in embodiments of the present invention. Accordingly, the term “comprising” encompasses the more restrictive terms “consisting essentially of” and “consisting of.”

For the purposes of the present invention, the term “and/or” means that one or more of the various compositions, compounds, polymers, ingredients, components, elements, capabilities, steps, etc., may be employed in embodiments of the present invention.

### DESCRIPTION

Disposable paper cups for containing hot beverage compatible with thermoformed, polystyrene sip beverage lids have been produced for many decades. For reasons of recyclability, resin cost, styrene health concerns, etc., thermoformed polypropylene beverage sip lids has been sought by customers for more than a decade. Polypropylene (when in the form of a homopolymer) is semi-crystalline and may be in three different crystal forms known as α, β, and γ. Alpha-type nucleating agents may be added to polypropylene to increase the rate of crystallization (faster cycle), improve stiffness and strength, improve clarity, etc. Commercial polypropylene compositions may comprise primarily the isotactic polypropylene isomer which may have a melting point that ranges from about 160 to about 166° C. (from about 320 to about 331 F), depending how much atactic isomer is also present and the degree of α-phase crystallinity. Polypropylene is normally tough and flexible. Polypropylene may be made to be translucent when uncolored but may also be made opaque or colored by including colorants, e.g., pigments, tints, etc.

Prior attempts to produce fluid material container closures, such as a beverage sip lids, from polypropylene polymer compositions have generally been unsuccessful due largely to the tendency of such beverage sip lids to drip at the intersection of the lid with the sideseam overlap on the upper rim/brim/lip of the beverage cup. For example, beverage lid drip rates of about 1 gram or below per 20 seconds may be obtained from beverage (coffee) lids made from polystyrene polymer compositions. By contrast, prior beverage (coffee) sip lids made from polypropylene polymer compositions have had drip rates in excess of about 2 grams per 20 seconds.

In embodiments of fluid material container closures, such as a beverage sip lids, of the present invention, it has discovered that, by aligning (or substantially aligning) the position of beverage sip hole of the lid with the machine direction (MD) of web (e.g., sheet) travel, advancement, movement, etc., during the manufacturing (thermoforming) process of preparing a beverage sip lid comprising a polypropylene polymer composition, by forming β-phase crystals in the polypropylene polymer during the manufacturing (thermoforming) process, or both, the beverage lids may be thermoformed from such polypropylene polymers compositions which may have significantly improved drip rates, i.e., about 1 gram or less per 20 seconds.

The resulting characteristics of a thermoformed article in the form of a fluid material container closure made from such polypropylene polymer compositions, for example, a beverage sip lid, may, in part, be determined by the thermoforming process conditions used to produce that article. Alpha and beta crystalline regions of the polypropylene polymer may be initiated, induced, grown, and stretched during the formation of such thermoformed articles. The relative size and amount of these crystals may also play a role in the performance of the resulting article. For example, β-phase crystals formed in the web comprising the polypropylene polymer composition during the extrusion and roll stand chill roll steps may be partially or totally consumed in the oven section of a thermoformer. Beta-phase polypropylene polymer crystals may also revert to the more stable, higher density α-phase crystals when the article is thermoformed from the web (e.g., sheet). By including, for example, one or more β-phase type polypropylene polymer nucleating agents in the polypropylene polymer composition, it has now been discovered that fluid material container closures, such as beverage cup sip lids, made from such polypropylene polymer compositions undergoing a β-phase type nucleation during thermoforming may substantially improve the drip rate of such polypropylene polymer composition-containing beverage cup lids, i.e., lower the drip rate. The relevant characteristics in inducing β-phase crystalline formation in the polypropylene polymer composition may include: (a) melting at lowering temperatures, such as about 150° C. (302° F.) or less, during thermoforming; (b) more ductility, of the thermoformed web, meaning lower mechanical forces may be required for stretching the thermoformed web; (c) transforming of the polypropylene polymer composition to the α crystalline phase upon stretching of the thermoformed web (sheet); (d) undergoing more uniform drawing of the thermoformed web (i.e., thinning of the wall thickness of the thermoformed article) as the thermoformed web is stretched over the thermoforming mold, and thus the thermoformed article may exhibit microvoiding, i.e., the presence of relatively small voids as the lower density β-phase crystals are converted to higher density α-phase crystals which then cause opacification of the thermoformed article.

The molecules of the polypropylene polymers present in the thermoformed article may also be oriented during the extrusion of web (sheet) comprising the polypropylene polymer composition, as well as by subsequent thermoforming thereof. For example, there may be edge orientation effects associated with the extruder die in that the polypropylene polymer composition extruded from the die may be more oriented in the machine direction (MD), such machine direction (MD) molecular orientation effects tending to be greater at the edges of the extruded web relative the middle of that web (due to the greater amount of shear caused by the extruder die at edges of the web relative to the middle thereof). Thermoforming of the extruded web comprising the polypropylene polymer composition over the thermoforming mold may then further stretch the solid phase extruded web to induce such orientation effects, but to a lesser degree than the orientation effects caused by extrusion of the polypropylene polymer composition into a web (sheet). Because fluid material container closures such as beverage (e.g., coffee) sip lids tend to have a shallower draw (i.e., the molded articles are shallower in depth), such molecular orientation effects may different, and to a lesser extent relative to article having a deeper draw (i.e., molded articles such as beverage cups having deeper in depth). Such molecular orientation effects may also induce anisotropy (i.e., directional dependency) in the thermoformed article which may affect the drip rate of a fluid material container closure, such as a cup (beverage) sip lid having an annular (circular) perimeter.

In addition, the isotactic isomer of a polypropylene homopolymer has a glass transition temperature (T_{g}) below room temperature (e.g., 0° C.). Because beverage sip lids may be stored above that T_{g}, such lids may undergo molecular (e.g., crystallinity) changes to reduce stresses that are molded into and present in the thermoformed article. Crystallization effects in the polypropylene polymer may also continue as these beverage sip lids are stored prior to use. The drip rate may also change as these articles (e.g., beverage sip lids) made from polypropylene polymer compositions are stored over time. Beverage sip lids fresh off a machine (e.g., a thermoformer) may be larger in all respective dimensions (e.g., diameter, etc.) compared to when these lids are applied (secured) to a cup several days, months, etc. after manufacture. Due to a lack of interference between the beverage sip lid and the cup it is secured to, a freshly molded lid may have a higher drip rate. As the polypropylene polymer present in the article crystallizes over time into the α-phase, the drip rate may decrease, and may reach a minimum within a few days. As α-phase crystallization of the polypropylene polymer composition becomes more complete, the presence of molded in and crystallization-induced stresses may reach a maximum value, thus leading to a minimized leak drip rate within, for example, a few days. Conversely, the maximum stress may be relieved due to molecular changes during storage above the T_{g} of the polypropylene polymer with the drip rate gradually increasing over time, thus leading to a quasi-steady state value within, for example, a few months to years after the article (e.g., beverage sip lid) is produced. The crystallization rate and extent thereof, as well as the shrinkage rate and extent thereof may be affected by other optional additives such as mineral fillers, colorants, carrier resins (i.e., powdered mineral pigments mixed with a plastic resin to yield a higher density pellet, for example, a pellet which is about 60% mineral, and about 40% resin as the “carrier” to improve the dispersion of the mineral pigment and to provide an easier to handle pellet for blending at the thermoformer), processing aids, etc., present in the polypropylene polymer composition, as well as the thermal history of the thermoformed article.

High impact polystyrene (HIPS) resins such as Americas Styrenics 1170 used to produce thermoformed beverage (e.g., coffee cup) lids may have a flexural modulus of approximately 210,000 kpsi. By contrast, polypropylene polymer resins having a similar modulus when made into beverage (e.g., coffee) sip lids may have higher drip rates compared to those made from such HIPS resins. Instead, it has been found in embodiments of the present invention that thermoformed beverage (e.g., coffee) sip lids made of polypropylene polymer resins having a flexural modulus of at least about 230,000 kpsi, for example, from about 230,000 to about 300,000 kpsi have lower drip rates relative to such lids made from polypropylene polymer resins having a flexural modulus of, for example, from about 180,000 to about 220,000 kpsi, such lids otherwise having the same or similar mass, starting gauge, thickness, etc.

Beverage sip lid designs may include, for example, “interference fit” and “plug fit” securement types for securing the lid to the lip (e.g., rim or brim) of the cup. “Interference fit” securement type lids may snap onto the rim/brim/lip of the cup with an audible click or seating feel. By contrast, “plug fit” securement type lids may also snap onto the rim/brim/lip of the cup, but may also require pressing onto the cup rim/brim/lip for a securely fitting the lid to the cup. “Interference fit” securement type beverage sip lids have a line of contact or engagement at the widest point of the cup rim/brim/lip. By contrast, “plug fit” securement type lids have a depressed inner annulus forming a deeper inner securement groove or recess which reduces the exposure of the cup rim/brim/lip to beverages (e.g., coffee) present in the cup and which may also provide additional contact and engagement between the beverage sip lid and the cup interior which may aid in reducing the drip rate of the beverage in the cup. “Plug fit” securement type beverage sip lids may also have generally greater manufacturing tolerances relative to “interference fit” securement type beverage sip lids with respect to reducing drip rates. “Plug fit” securement type beverage sip lids tend to have lower drip rates compared to interference “fit” securement type beverage sip lids, but effects of variables such as the angular position of the beverage sip hole formed in the thermoformed beverage lid in the web (sheet) on drip rate may follow the same or similar trends for both “plug fit” and “interference fit” securement types.

High impact polystyrene (HIPS) beverage sip lids may be produced from a web (sheet) having, for example, a wall thickness of approximately 17 mils (gauge) to form lids having a maximum wall thickness of from about a 14 to about a 17 mils. For example, 12 oz coffee cup sip lids may have a mass of from about 3 to about 5 g. By contrast, polypropylene polymer, being a lower density material when not blended with, for example, mineral fillers, may provide in such thermoformed beverage sip lids a similar mass to thermoformed lid made from HIPS but may need to be produced with a web (sheet) having a greater wall thickness of from about a 14 to about 30 mils (gauge).

Beverage lid fit may be defined as the ability to apply and secure a lid to a cup rim/brim/lip without using excessive force or causing the rim/brim/lip of the cup to be crushed or to cause the sidewall of the cup to buckle. When evaluating beverage lid fit, a range of shrinkages of from about 2 to about 19% with lid designs of the “interference fit” and “plug fit” type may occur. In such evaluations, freshly molded beverage sip lids of the various sizes may be applied and secured to the rim/brim/lip of the cups. These beverage sip lids may be allowed to age to allow for shrinkage due to crystallization of the polypropylene polymer or due to other processes or effects such as relief of molded-in stresses. “Interference fit” type beverage sip lids made of neat polypropylene polymer (i.e., polypropylene polymer resin without color or other additives) when freshly molded may have shrinkage of 5% (i.e., a change of 5 mils in a dimension per inch of original length of that dimension) which may then increase to 16% shrinkage over time. “Plug fit” type beverage sip lids comprising the same polypropylene polymer composition and a having the same thickness (gauge) may have shrinkage, when freshly molded of, for example, about 11% which may then increase to about 13%. Addition of mineral fillers or other additives may also affect the initial shrinkage level, the rate of shrinkage, and the extent of shrinkage. Accordingly, cup lid fit may also be expressed as a percentage of diameter shrinkage, i.e., shrinkage of the diameter of the beverage sip lid. In the case of “plug fit” type lids, the shrinkage may be more meaningful when normalized to the width of the cup rim/brim/lip due to the smaller difference in shrinkage between fresh and aged lid fit and fresh and aged drip rate.

To increase the rate of shrinkage, a sample set of freshly made lids may be placed in boiling water for 1 hour to bring the polypropylene polymer crystallization process to near completion. (Similar results may also be achieved by waiting (aging) the beverage sip lids for one week.) Lids which have been aged for one year may also be placed in boiling water for one hour, and the effects measured, including any increased shrinkage. Assuming that the crystallization process of the polypropylene polymer has concluded within this one year storage period, mechanical stresses are then assumed to be responsible for the shrinkage in the older lids.

Mineral filler loading may be used to increase flexural modulus, reduce cost, and increase thermal resistance of beverage sip lids and may also affect the final drip rate. Even so, higher mineral filler loadings in thermoformed articles made from polypropylene polymer compositions may result in the recycled polypropylene-containing articles being considered a contaminant when included with other polymer resins such as polyethylene terephthalate (PET). Also, mineral filler loadings over about 30% by weight (e.g., upwards of about 40% by weight) may result in beverage sip lids made from such polypropylene polymer compositions being more brittle and breaking more easily when applied/secured to the rim/brim/lip of a cup.

The melt flow rate (MFR) or melt flow index (MFI) of the polypropylene polymer composition may also be used as measure how easily the molten raw polypropylene polymer may flow during the thermoforming process. Polypropylene polymers with a higher MFR may conform to the thermoforming molds more easily during application of pressure and vacuum in the thermoforming processes. (As the melt flow increases, however, some physical properties, like impact strength, of the polypropylene polymer may also decrease, so a balancing of such properties may be required.) Melt flow rates of from about 1 to about 4 grams per 10 minutes (g/10 min) may be used for thermoforming webs (sheets) made from polypropylene polymer compositions. It may also be advantageous to use an inline extruder-thermoformer system to control polypropylene polymer crystallization to optimize the drip rate of the thermoformed beverage sip lids. Preforming and winding rolls of the extruded web (sheet) for later thermoforming may also result in crystallization of the polypropylene polymer to different extents and at different rates as the web (sheet) is stored above the T_{g} of the polypropylene polymer. Mechanical stresses may be resolved differently between sheet forms and article forms. Differences in crystallization pathways may result in different levels of shrinkage and drip rate. In particular, the combination of these factors (e.g., crystallization, orientation, shrinkage, mechanical stress, etc.) may contribute to changes in the local flexural modulus of the polypropylene polymer (and thus potentially affecting the drip rate of the resulting thermoformed beverage sip lids) so that keeping these factors as predictable as possible may be desirable.

Embodiments of the thermoformed articles according to the present invention in the form of fluid material container closures, such as beverage sip lids, for fluid material containers, such as beverage (coffee) cups, have a lower container-securing portion having an inner plug fit annular groove for removably securing the fluid material container closure to an upper rim of a fluid material container, as well as an upper generally dome-shaped fluid material-dispensing portion extending generally upwardly from the lower container-securing portion and having a fluid material-dispensing orifice formed therein. These fluid material container closures may comprise a polypropylene polymer composition having from about 50 to 100% (for example, from about 83 to 100% by weight, such as from about 90 to 100% by weight) polypropylene polymer having a flexural modulus of at least about 230,000 kpsi (for example, from about 230,000 to about 350,000 kpsi, such as from about 250,000 to about 300,000 kpsi). The fluid material container closure has a wall thickness in the range of from about 10 to about 30 mills, such as from about 14 to about 24 mils. When the fluid material container closure is removably secured to the upper rim (e.g., brim/lip) of the fluid material container, the removably secured fluid material container closure provides a drip rate of about 1 gram or less per 20 seconds.

Embodiments of thermoformed articles according to the present invention especially relate to thermoformed reclosable beverage sip lids, the reclosable beverage sip lid having a lower generally annular cup rim-securing portion having an inner plug fit annular groove for removably securing the fluid material container closure to an upper rim (e.g., brim/lip) of a beverage cup, as well as an upper generally frustoconical-shaped beverage-dispensing portion extending generally upwardly from the lower rim-securing portion of the reclosable beverage sip lid and having a beverage-dispensing sip hole formed therein. These reclosable beverage sip lids may comprise a polypropylene polymer composition having the amounts of polypropylene polymer, the flexural modulus, wall thicknesses, and drip rates as described above.

Embodiments of the present invention further relate to processes for preparing thermoformed fluid material container closures. These processes use a thermoformable web comprising from about 50 to 100% polypropylene having a flexural modulus of at least about 230,000 kpsi and having a machine direction (MD) and a cross machine direction (CD) orthogonal to the machine direction (MD) with a web width in the range of from about 20 to about 55 inches (such as from about 24 to about 50 inches) in the cross machine direction (CD)]. This thermoformable web may then be thermoformed by using a fluid material closure-forming mold (may be male mold or female mold) having a lower fluid material container-securing forming mold section and a generally dome-shaped upper fluid material-dispensing forming mold section extending generally upwardly from the lower mold section to provide a thermoformed fluid material container closure having a lower container-securing portion having formed therein an inner a plug fit annular groove for removably securing the fluid material container closure to an upper rim of a fluid material container and a generally dome-shaped upper fluid material-dispensing portion extending generally upwardly from the lower container-securing portion. In the upper fluid material-dispensing portion of the thermoformed fluid material container closure is then formed a fluid dispensing orifice which is substantially aligned with the machine direction (MD) of the thermoformable web.

Embodiments of the process of the present invention especially relate to preparing a thermoformed reclosable beverage sip lid. These processes also use a thermoformable web as described above in the form of a thermoformable sheet. This thermoformable sheet may then be thermoformed with a reclosable beverage lid-forming mold having a generally annular lower cup lip-securing portion forming mold section and an upper generally frustoconical-shaped beverage-dispensing portion forming mold section extending generally upwardly from the lower lip-securing mold forming portion to provide a thermoformed reclosable beverage lid having a lower generally annular cup lip-securing portion having an inner a plug fit annular groove for removably securing the beverage sip lid to an upper lip of a beverage cup and an upper generally frustoconical-shaped beverage-dispensing lid portion extending generally upwardly from the lower cup lip-securing portion. In the upper beverage-dispensing portion of the thermoformed reclosable beverage sip lid is then formed a beverage-dispensing sip hole which is substantially aligned with the machine direction (MD) of the thermoformable sheet. The thermoformable sheet may have the widths described above for the thermoformable web.

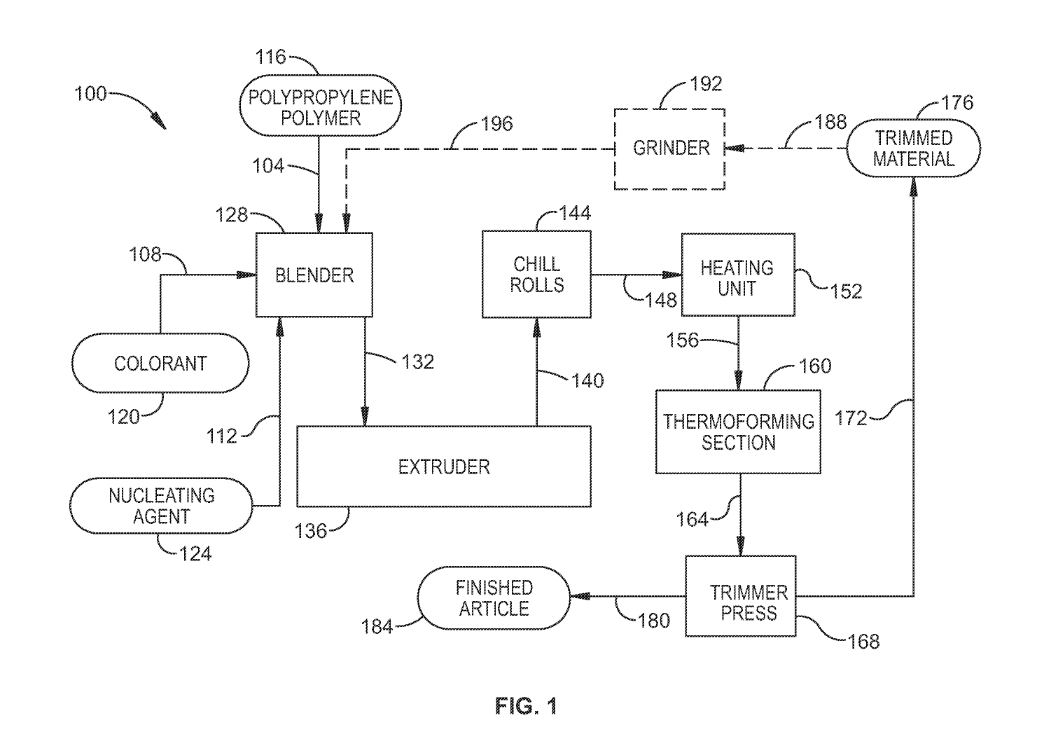

An embodiment of the process of the present invention for preparing a thermoformed article is further schematically illustrated in FIG. 1 which shows a thermoforming system, indicated generally as 100. In system 100, and as indicated by arrows 104, 108, and 112, Polypropylene Polymer (e.g., Flint Hills Resource 21N2A) 116, Colorant (e.g., pelletized powdered mineral pigment in a carrier resin) 120, and Nucleating Agent (e.g., a β-phase crystal nucleating agent such as Mayzo MPM®2000) 124 are added to and blended together in a Blender 128 (e.g., a gravimetric blender). (In some embodiments, one or more mineral fillers such as talc, calcium carbonate, etc., may be added to Blender 128.) As indicated by arrow 132, the substantially homogeneously blended mixture of Polypropylene Polymer 116, Colorant 120 and Nucleating Agent 124 (forming the polypropylene polymer composition) are added to Extruder 136 (e.g., having sheet forming die such as a flat or coat-hanger type extrusion die) and then extruded, as indicated by arrow 140, into, for example, a fluid, melted (web) sheet (e.g., having a width in the range of from about 24 to about 50 in the cross machine direction (CD)) of the polypropylene polymer composition.

The fluid/melted sheet 140 of the polypropylene polymer composition may then be passed through, for example, a series Chill Rolls 144 (e.g., nip stack or calendar stack rolls) to smooth out and to lower to the temperature of sheet 140 so as to provide a solid, relatively smooth thermoformable sheet (e.g., having a thickness in the range of from about 10 to about 20 mils), as indicated by arrow 148, having a temperature of, for example, in the range of from about 40° to about 250° F. (e.g., from about 70° to about 90° F.). Chilled sheet 148 may then be passed through a Heating Unit (e.g., a remelt oven) 152, where cold sheet 148 may be softened or melted at a temperature, for example, in the range of from about 265° to about 450° F. (e.g., from about 270° to about 380° F.), to provide a thermoformable sheet, as indicated by arrow 156. (In some embodiments, sheet 140 may be optionally passed through a preheater roll stack prior to Heater Unit 152 to increase the temperature of sheet 148.) Thermoformable sheet 156 may then be passed through a Thermoforming (molding) Section 160 at a temperature, for example, in the range of from about 265° to about 450° F. (e.g., from about 280° to about 380° F.), to provide, as indicated by arrow 164, thermoformed or molded articles. Thermoformed articles 168 may then be passed through, for example, a Trimmer Press 168 to remove, as indicated by arrow 172 excess Trimmed Material (e.g., flashing) 176, and to provide, as indicated by arrow 180, Finished Article 184. As indicated by dashed arrow 188, Trimmed Material 176 may be sent to a Grinder (or chopper) (indicated by dashed box 192) to provide size reduced recycled material, as indicated by dashed arrow 196. The size reduced recycled material 196 may then added (along with virgin Polypropylene Polymer 116, Colorant 120, and Nucleating 124) to Blender 128.

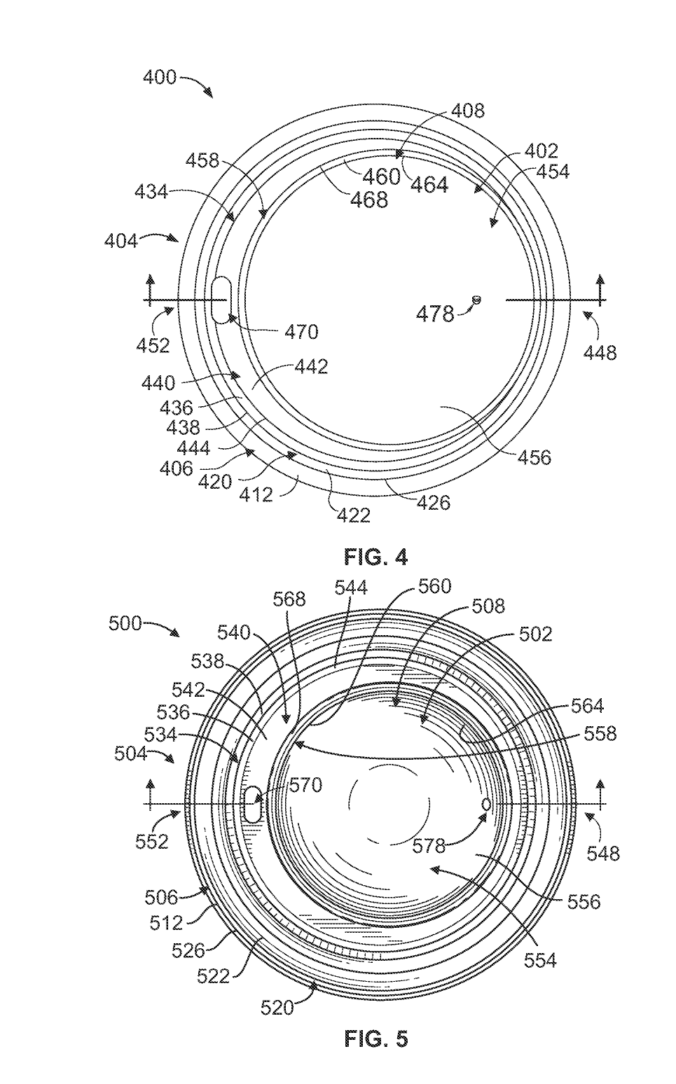

Referring to FIGS. 2 and 3, FIG. 2 illustrates a dome-shaped male mold, indicated generally as 200, for thermoforming dome-shaped beverage sip lids having an “interference fit” attachment and securement mechanism for the upper rim/brim/lip of a beverage cup. (Dome-shaped male mold 200 may also be in an inverted configuration to provide a female mold.) As shown in FIG. 2, dome-shaped male mold 200 has an outer surface generally indicated as 202, and comprises a lower mold section 204 for forming the lower “interference fit” container-securing portion of the container closure (e.g., lower beverage cup-securing portion 404 of beverage sip lid 400, as described below), and an upper generally dome-shaped (e.g., a generally frustoconical shape as illustrated in FIG. 2) mold section 208 for forming an upper generally dome-shaped (e.g., a generally frustoconical shape as illustrated in FIG. 4) fluid-dispensing portion of the container closure (e.g., upper beverage-dispensing portion 408 of beverage sip lid 400, as described below). Lower mold section 204 comprises a lower base segment 212 for forming a generally downwardly extending generally annular-shaped skirt of the container closure (e.g., skirt 406 of beverage sip lid 400, as described below), and which has a generally vertically extending generally circular-shaped surface 214 and a generally horizontally extending generally annular-shaped surface 216 connected at generally circular edge 220. Lower mold section 204 further comprises an upper generally annular convex curve-shaped mold segment 222 for forming the container-securing part of the container closure (e.g., beverage cup-securing part 420 of “interference fit” lower beverage cup-securing portion 404 of beverage sip lid 400, as described below). Lower mold section 204 also comprises an intermediate generally annular mold segment 224 connected to mold surface 216 at generally circular lower edge 226 and to mold segment 222 at generally circular upper edge 228.

As further shown by FIG. 2, upper mold section 208 comprises an inwardly sloping generally dome-shaped (e.g., a generally frustoconical shape as illustrated in FIG. 2) mold surface 236 connected to mold segment 222 at generally circular edge 238. Upper mold section 208 further comprises an upper generally annular mold surface 240 connected to mold surface 236 at generally annular edge 244. As shown by FIG. 2, arrow 248 indicates the rearward lower side of upper mold surface 240/upper mold section 208, while arrow 252 indicates the forward higher side of upper mold surface 240/upper mold section 208. Upper mold section 208 also comprises a generally horizontally extending generally circular and concave bowl-shaped lower mold surface 256 which forms the generally circular-shaped and bowl-shaped part of the fluid-dispensing portion of the container closure (e.g., bowl-shaped and circular-shaped part 456 of beverage sip lid 400, as described below), as well as a generally vertically extending and generally frustoconical-shaped inner mold surface 260 which forms the generally vertically extending annular wall part of the fluid-dispensing portion of the container closure (e.g., frustoconical-shaped wall 458 having outer surface 460 of beverage sip lid 400, as described below) and which is connected to lower mold surface 256 by a generally circular lower edge 264 and to upper mold surface 240 by generally circular upper edge 268.

As shown FIG. 2, dome shaped male mold 200 also has one or more of a plurality of sets of vacuum holes formed therein. For example, a first plurality of generally circularly-spaced vacuum holes 272 (for example, sixteen total, indicated as 272-1 through 272-16) may be formed in mold surface 216 proximate edge 226. A second plurality of generally circularly-spaced vacuum holes 276 (for example, sixteen total, indicated as 276-1 through 276-16) may be formed in edge 228. A third plurality of generally circularly-spaced vacuum holes 280 (for example, sixteen total, indicated as 280-1 through 280-16) may be formed in edge 238. A fourth plurality of generally circularly-spaced vacuum holes (for example, sixteen total, indicated as 292-1 through 292-16) may be formed in mold surface 256 proximate edge 264. Although not shown, mold 200 has a plurality vacuum plenums chambers extending generally vertically therethrough and upwardly to connect with vacuum holes 272-1 through 272-16, 276-1 through 276-16, 280-1 through 280-16, and 292-1 through 292-16 to assist in drawing air through these vacuum holes during vacuum molding when carrying out thermoforming in Thermoforming Section 160.

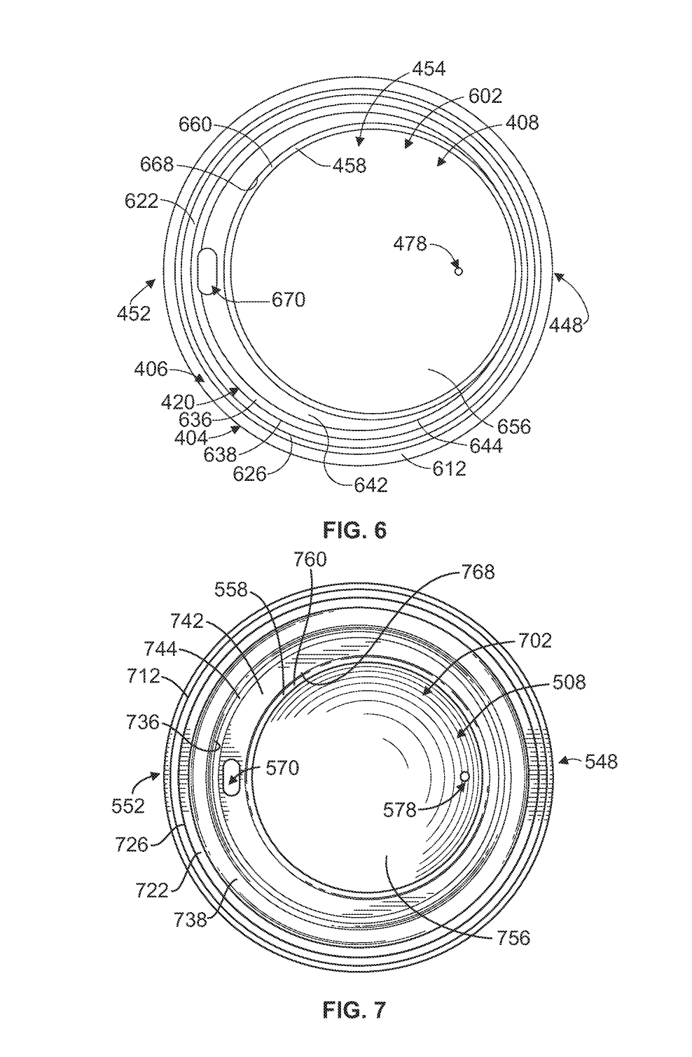

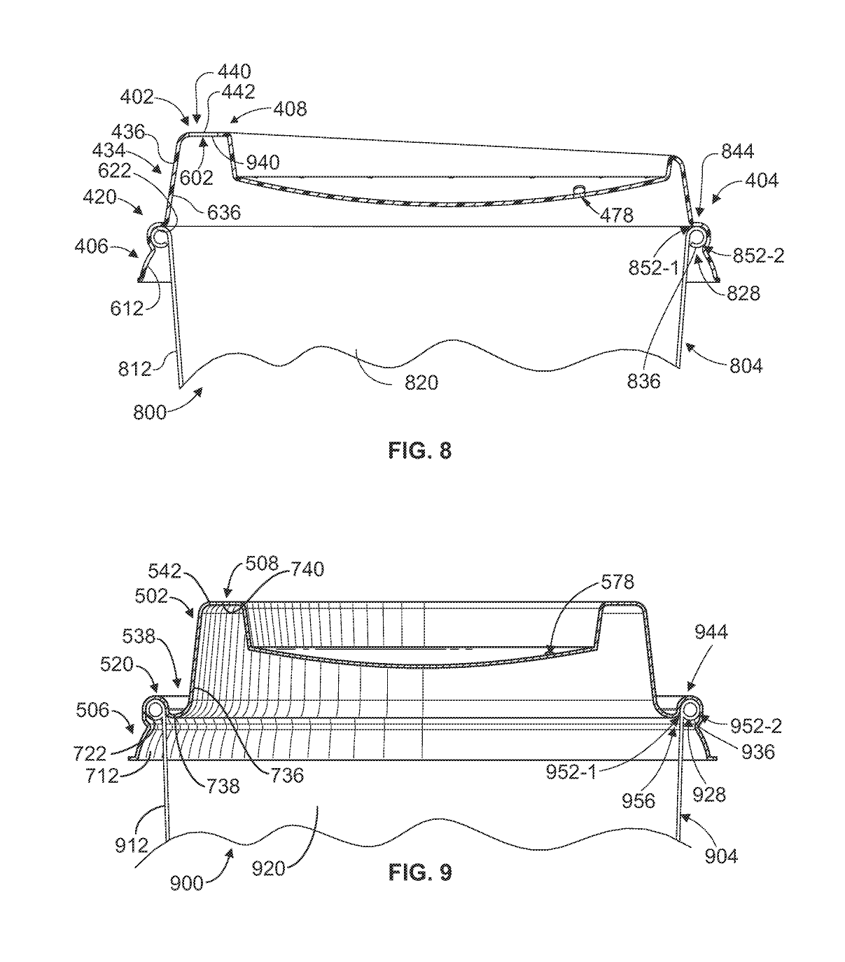

Referring now to FIGS. 4, 6, and 8, FIG. 4 illustrates a dome-shaped beverage sip lid (formed in Thermoforming Section 160 using dome-shaped male mold 200) which is indicated generally as 400. (As described below with respect to FIGS. 10 through 13, embodiments of Thermoforming Section 160 may use more than one, e.g., a plurality of such dome-shaped male molds 200 to form a plurality of dome-shaped beverage lids 400). As further illustrated in FIG. 4, dome-shaped beverage sip lid 400 has an outer surface, indicated generally as 402, and comprises a lower beverage cup-securing portion, indicated generally as 404 (for securing, as well as for sealing beverage sip lid 400 by an “interference fit” attachment and securement mechanism to, for example, the upper rim, brim, or lip of a beverage cup), having a lower generally annular skirt 406 (see FIGS. 6 and 8), and an upper generally dome-shaped (e.g., a generally frustoconical shape as illustrated and shown in FIG. 8) fluid (beverage)-dispensing portion, indicated generally as 408. Lower beverage cup-securing portion 404 is formed by lower mold section 204 of dome-shaped male mold 200, while upper dome-shaped (e.g., a generally frustoconical shape as illustrated and shown in FIG. 8) fluid (beverage)-dispensing portion 408 is formed by upper mold section 208 of dome-shaped (e.g., a generally frustoconical shape as illustrated in FIG. 2) male mold 200.

As shown in FIGS. 4, 6, and 8, annular skirt 406 has an outer surface 412. Lower beverage cup-securing portion 404 further comprises a generally annular convex curve-shaped beverage cup-securing part 420 (from which annular skirt 406 extends generally downwardly and outwardly therefrom) having an outer surface 422. Outer skirt surface 412 and outer beverage cup-securing part surface 422 are connected by a generally circular edge 426. Upper fluid-dispensing portion 408 comprises an upwardly and inwardly sloping generally domed-shaped (e.g., a generally frustoconical shape as illustrated and shown in FIG. 8) part 434 having an outer surface 436. Outer dome-shaped part surface 436 and outer beverage cup-securing part surface 422 are connected by a generally circular edge 438. Upper fluid-dispensing portion 408 further comprises an upper generally annular-shaped part 440 having an outer surface 442. Outer surface 442 and outer surface 436 are connected by a generally circular edge 444. Arrow 448 indicates generally the rearward lower side of fluid (beverage)-dispensing portion 408, while arrow 452 indicates generally the forward higher side of fluid-(beverage) dispensing portion 408. Upper fluid (beverage)-dispensing portion 408 also comprises a generally horizontally extending bowl-shaped and circular-shaped part 454 having an outer generally concave-shaped surface 456, as well as a generally frustoconical-shaped wall 458 extending generally vertically from bowl-shaped/circular-shaped part 456 and having an outer surface 460. Outer surface 456 and outer surface 460 are connected by generally circular lower edge 464, while outer surface 442 and outer surface 460 are connected by generally circular upper edge 468. A generally oval-shaped beverage sip hole 470 is formed in part 440/surface 442 proximate higher side 452 of fluid (beverage)-dispensing portion 408. A generally circular-shaped vent hole 478 may also be formed in bowl-shaped part 454/surface 456 proximate lower side 448 of fluid (beverage)-dispensing portion 408. (Sip hole 470, as well as vent hole 478 may be formed, for example, as part of the operation of Trimmer Press 168 to provide Finished Article 184.)

Referring now to FIGS. 6 and 8, dome-shaped beverage lid 400 has an inner surface, indicated generally as 602, which includes an inner surface 612 of annular skirt 406. Beverage cup-securing part 420 also has an inner generally annular-shaped concave undercut groove surface 622 providing an “interference fit” attachment and securement mechanism (see FIG. 8 which is discussed below) which secures, as well as seals, beverage sip lid 400 to, for example, the upper rim, brim, or lip of a beverage cup (e.g., cup 800, as discussed below). Inner skirt surface 612 and inner beverage cup-securing groove surface 622 are connected by a generally circular edge 626. Dome (e.g., frustoconical)-shaped part 434 also has an inner inwardly and upwardly tapering surface 636. Inner generally dome-shaped (e.g., a generally frustoconical shape as illustrated and shown in FIG. 8) surface 636 and inner beverage cup-securing groove surface 622 are connected by a generally circular edge 638. Annular-shaped part 840 of upper fluid (beverage)-dispensing portion 408 has an upper generally annular-shaped inner surface 442. Inner surface 642 and inner surface 636 are connected by a generally circular edge 644. Bowl-shaped/circular-shaped part 454 has a generally convex inner surface 656. Wall 658 also has an inner generally frustoconical-shaped surface 660. Inner surface 642 and inner surface 660 are connected by a generally circular upper edge 668.

Referring now to FIG. 8, a suitable fluid-dispensing container, such as a beverage cup, is indicated generally as 800. Beverage cup 800 is illustrated in FIG. 8 as having a generally frustoconical-shaped outwardly sloping wall 804 with an outer surface 812 and an inner surface 820. Beverage cup 800 further comprises a generally annular and tubular-shaped rolled rim, brim, or lip 828 which is extends outwardly from wall 804 and then inwardly towards outer surface 812 of wall 804, and has an outer circumferential surface 836. Arrow 844 indicates the circumferential “interference fit” securement groove defined by inner beverage lid securing groove surface 622 for receiving outer circumferential surface 836 of rim/brim/lip 828, and thus reclosably securing, mounting, connecting, attaching, joining, etc., beverage sip lid 400 on/to rim/brim/lip 828 of beverage cup 800 by an “interference fit” attachment and securement mechanism, the attachment and securement of beverage sip lid 400 on/to rim/brim/lip 828 of beverage cup 800 which may be signaled by an audible “snap” sound. Arrow 852-1 indicates the inner seal point, while arrow 852-2 indicates the outer seal point of inner groove surface 622 of “interference fit” securement groove 844 with outer circumferential surface 836. The distance between inner seal point 852-1 and outer seal point 852-2 thus shows the extent to which inner groove surface 622 of “interference fit” securement groove 844 of beverage sip lid 400 is in direct contact with rim/brim/lip 828 of beverage cup 800 to prevent potential leakage of beverage from cup 800.

By contrast, FIG. 3 illustrates an embodiment of a dome-shaped male mold, indicated generally as 300 for use in embodiments of the process (e.g., as illustrated in FIG. 1) of the present invention in thermoforming dome-shaped beverage sip lids having a “plug fit” attachment and securement mechanism for the upper rim/brim/lip of a beverage cup. (Similar to dome-shaped male mold 200, dome-shaped male mold 200 may also be in an inverted configuration to provide a female mold.) As shown in FIG. 3, dome-shaped male mold 300 has an outer surface generally indicated as 302, and comprises a lower mold section 304 for forming the lower “plug fit” container-securing portion of the container closure (e.g., lower beverage cup-securing portion 504 of beverage sip lid 500, as described below), and an upper generally dome-shaped (e.g., a generally frustoconical shape as illustrated in FIG. 3) mold section 308 for forming an upper generally dome-shaped (e.g., a generally frustoconical shape as illustrated in FIGS. 5, 7, and 9) fluid-dispensing portion of the container closure (e.g., upper beverage-dispensing portion 508 of beverage sip lid 500, as described below). Lower mold section 504 comprises a lower base segment 512 for forming a generally downwardly extending generally annular-shaped skirt of the container closure (e.g., skirt 506 of beverage sip lid 500, as described below), and which has a generally vertically extending generally annular-shaped wall surface 314 and a generally circular-shaped edge 316 connected to wall surface 314. Lower mold section 304 further comprises an upper convex generally annular hump-shaped mold segment 322 for forming the container-securing part of the container closure (e.g., beverage cup-securing part 520 of “plug fit” lower beverage cup-securing portion 504 of beverage sip lid 500, as described below). Lower mold section 304 also comprises an intermediate generally annular mold segment 324 connected at edge 316 to wall surface 314 and to mold segment 322 at generally circular upper edge 328.

As further shown by FIG. 3, upper mold section 308 comprises an inwardly sloping generally dome-shaped (e.g., a generally frustoconical shape as illustrated in FIG. 3) mold surface 336 connected to mold segment 322 by a generally horizontal annular mold surface edge 338. Upper mold section 308 further comprises an upper generally annular mold surface 340 connected to mold surface 336 at generally annular edge 344. As shown by FIG. 3, arrow 348 indicates the rearward lower side of upper mold surface 340/upper mold section 308, while arrow 352 indicates the forward higher side of upper mold surface 340/upper mold section 308. Upper mold section 308 also comprises a generally horizontally extending generally circular and concave bowl-shaped lower mold surface 356 which forms the generally circular-shaped and bowl-shaped part of the fluid-dispensing portion of the container closure (e.g., bowl-shaped and circular-shaped part 556 of beverage sip lid 500, as described below), as well as a generally vertically extending and generally frustoconical-shaped inner mold surface 360 which forms the generally vertically extending annular wall part of the fluid-dispensing portion of the container closure (e.g., frustoconical-shaped wall 558 having outer surface 560 of beverage sip lid 500, as described below) and which is connected to lower mold surface 356 by a generally circular lower edge 364 and to upper mold surface 340 by generally circular upper edge 368.

Similar to mold 200 and as shown in FIG. 3, dome shaped male mold 300 also has one or more of a plurality of sets of vacuum holes formed therein. For example, a first plurality of generally circularly-spaced vacuum holes 372 (for example, sixteen total, indicated as 372-1 through 372-16) may be formed in edge 316. A second plurality of generally circularly-spaced vacuum holes 376 (for example, sixteen total, indicated as 376-1 through 376-16) may be formed in edge 328. A third plurality of generally circularly-spaced vacuum holes 380 (for example, sixteen total, indicated as 380-1 through 380-16) may be formed in mold surface 338. A fourth plurality of generally circularly-spaced vacuum holes (for example, sixteen total, indicated as 392-1 through 392-16) may be formed in mold surface 356 proximate edge 364. Although not shown, mold 300 has a plurality vacuum plenums chambers extending generally vertically therethrough and upwardly to connect with vacuum holes 372-1 through 372-16, 376-1 through 376-16, 380-1 through 380-16, and 392-1 through 392-16 to assist in drawing air through these vacuum holes during vacuum molding when carrying out thermoforming in Thermoforming Section 160.

While certain elements and surfaces of molds 300 and 200 share similarities in terms of shaping, etc., there are some distinct differences between these molds which are relevant to forming the “plug fit” attachment and securement mechanism with mold 300 in beverage sip lid 500 (as described below), versus the “interference fit” attachment and securement mechanism with mold 200 in beverage sip lid 400 (as also described below). In particular, and as shown by comparing FIG. 3 to FIG. 2, wall surface 314 of lower mold section 304 has a length significantly greater than that of vertical surface 214 of lower mold section 204, while horizontal surface 216 of lower mold section 204 is significantly wider than that of edge 316 of lower mold section 304. In addition, besides mold surface 336 being significantly wider compared to edge 238, as is also shown in FIG. 3, the combination of hump-shaped mold segment 322, mold surface 336, and mold surface convex curve-shaped mold segment 222 forms a relatively wider and deeper valley or trough indicated by arrow 396 in mold 300, compared to relatively narrower and shallower valley or trough indicated by arrow 296 in mold 200 and formed by the combination convex-shaped mold segment 222, edge 238, and mold surface 240.

Referring now to FIGS. 5, 7, and 9, FIG. 5 illustrates a dome-shaped beverage sip lid (formed in Thermoforming Section 160 using dome-shaped male mold 300) which is indicated generally as 500. (As also described below with respect to FIGS. 10 through 13, embodiments of Thermoforming Section 160 may use more than one, e.g., a plurality of such dome-shaped male molds 300 to form a plurality of dome-shaped beverage lids 500). As further illustrated in FIG. 5, dome-shaped beverage sip lid 500 has an outer surface, indicated generally as 502, and comprises a lower beverage cup-securing portion, indicated generally as 504 (for securing, as well as for sealing beverage sip lid 500 by a “plug fit” attachment and securement mechanism to, for example, the upper rim, brim, or lip of a beverage cup), having a lower generally annular skirt 506 (see FIGS. 7 and 9), and an upper generally dome-shaped (e.g., a generally frustoconical shape as illustrated and shown in FIG. 9) fluid (beverage)-dispensing portion, indicated generally as 508. Lower beverage cup-securing portion 504 is formed by lower mold section 304 of dome-shaped male mold 300, while upper dome-shaped (e.g., a generally frustoconical shape as illustrated and shown in FIG. 9) fluid (beverage)-dispensing portion 508 is formed by upper mold section 308 of dome-shaped (e.g., a generally frustoconical shape as illustrated in FIG. 3) male mold 300.

As shown in FIGS. 5, 7, and 9, annular skirt 506 has an outer surface 512. Lower beverage cup-securing portion 504 further comprises a generally annular humped-shaped beverage cup-securing part 520 (from which annular skirt 506 extends generally downwardly and outwardly therefrom) having an outer surface 522. Outer skirt surface 512 and outer beverage cup-securing part surface 522 are connected by a generally circular edge 526. Upper fluid-dispensing portion 508 comprises an upwardly and inwardly sloping generally domed-shaped (e.g., a generally frustoconical shape as illustrated and shown in FIG. 9) part 534 having an outer surface 536. Outer dome-shaped part surface 536 and outer beverage cup-securing part surface 522 are connected by a generally annular valley-shaped or trough-shaped surface 538 (see FIG. 9 which is discussed below). Upper fluid-dispensing portion 508 further comprises an upper generally annular-shaped part 540 having an outer surface 542. Outer surface 542 and outer surface 536 are connected by a generally circular edge 544. Arrow 548 indicates generally the rearward lower side of fluid (beverage)-dispensing portion 508, while arrow 552 indicates generally the forward higher side of fluid-(beverage) dispensing portion 508. Upper fluid (beverage)-dispensing portion 508 also comprises a generally horizontally extending bowl-shaped and circular-shaped part 554 having an outer generally concave-shaped surface 556, as well as a generally frustoconical-shaped wall 558 extending generally vertically from bowl-shaped/circular-shaped part 556 and having an outer surface 560. Outer surface 556 and outer surface 560 are connected by generally circular lower edge 564, while outer surface 542 and outer surface 560 are connected by generally circular upper edge 568. Similar to beverage sip lid 400, a generally oval-shaped beverage sip hole 570 is formed in part 540/surface 542 proximate higher side 552 of fluid (beverage)-dispensing portion 508. Also similar to beverage sip lid 400, a generally circular-shaped vent hole 578 may also be formed in bowl-shaped part 554/surface 556 proximate lower side 548 of fluid (beverage)-dispensing portion 508. (Sip hole 570, as well as vent hole 578 may be formed, for example, as part of the operation of Trimmer Press 168 to provide Finished Article 184.)

Referring now to FIGS. 7 and 9, dome-shaped beverage lid 500 has an inner surface, indicated generally as 702, which includes an inner surface 712 of annular skirt 506. Beverage cup-securing part 520 also has a relatively deep inner generally annular-shaped concave groove surface 722 (i.e., groove surface 722 is much deeper compared to shallower groove surface 622) complementary to the hump-shaped outer surface 522 to provide the “plug fit” attachment and securement mechanism (see FIG. 9 which is discussed below) which secures, as well as seals, beverage sip lid 500 to, for example, the upper rim, brim, or lip of a beverage cup (e.g., cup 900, as discussed below). Inner beverage cup-securing groove surface 722 is connected to inner surface 712 by a generally circular edge 726. Inner beverage cup-securing groove surface 722 is also connected to an inner generally annular ridge 738 (see especially FIG. 9 which is discussed below) which is complementary to outer valley-shaped/trough-shaped surface 538. Dome (e.g., frustoconical)-shaped part 534 also has an inner inwardly and upwardly tapering surface 736. Inner generally dome-shaped (e.g., a generally frustoconical shape as illustrated and shown in FIG. 9) surface 736 is connected at its lower end to inner annular ridge 738. Annular-shaped part 540 of upper fluid (beverage)-dispensing portion 508 has an upper generally annular-shaped inner surface 742. Inner surface 742 and inner surface 736 are connected by a generally circular edge 744. Bowl-shaped/circular-shaped part 554 has a generally convex inner surface 756. Wall 558 also has an inner generally frustoconical-shaped surface 760. Inner surface 742 and inner surface 760 are connected by a generally circular upper edge 768.

Referring now to FIG. 9, a suitable fluid-dispensing container, such as a beverage cup (similar to beverage cup 800 shown in FIG. 8), is indicated generally as 900. Similar to beverage cup 800, beverage cup 900 (as illustrated in FIG. 9) has a generally frustoconical-shaped outwardly sloping wall 904 with an outer surface 912 and an inner surface 920. Beverage cup 900 also further comprises a generally annular and tubular-shaped rolled rim, brim, or lip 928 which is extends outwardly from wall 904 and then inwardly towards outer surface 912 of wall 904, and has an outer circumferential surface 936. Arrow 944 indicates the circumferential “plug fit” securement groove defined by inner beverage lid securing groove surface 722 for receiving outer circumferential surface 936 of rim/brim/lip 928 for reclosably securing, mounting, connecting, attaching, joining, etc., beverage sip lid 500 on/to rim/brim/lip 928 of beverage cup 900 by a “plug fit” attachment and securement mechanism. Arrow 952-1 indicates the inner seal point, while arrow 952-2 indicates the outer seal point of inner groove surface 722 of “plug fit” securement groove 944 with outer circumferential surface 836. The distance between inner seal point 952-1 and outer seal point 952-2 thus also shows the extent to which inner groove surface 722 of “plug fit” securement groove 844 of beverage sip lid 500 is in direct contact with rim/brim/lip 928 of beverage cup 900 to prevent potential leakage of beverage from cup 800. Arrow 956 indicates the constricted circumferential opening or gap of “plug fit” securement groove 944 for receiving rim/brim/lip 928 of beverage cup 900.

A comparison of “plug fit” beverage sip lid 500 as secured on/to rim/brim/lip 928 of beverage cup 900 (see FIG. 9), versus “interference fit” beverage sip lid 400 as secured on/to rim/brim/lip 828 of beverage cup 800 (see FIG. 8) illustrates how and the degree to which the “plug fit” provided by “plug fit” securement groove 944 of beverage sip lid 500 is more securely attached and sealed to the beverage cup for purposes of inhibiting, preventing, etc., potential leakage of beverage from the cup. In particular, the distance between inner seal point 952-1 and outer seal point 952-2 (which defines the line of contact of inner groove surface 722 of “plug fit” securement groove 944 with rim/brim/lip 928) for “plug fit” lid 500 is much greater compared to the distance between inner seal point 852-1 and outer seal point 852-2 (which defines the line of contact of inner groove surface 622 of “interference fit” securement groove 844 with rim/brim/lip 828) for “interference fit” lid 400. As a result, because of the greater degree of contact between inner groove surface 722 of “plug fit” securement groove 944 and outer circumferential surface 936, “plug fit” securement groove 944 of lid 500 provides a greater degree of sealing (versus securement groove 844 of “interference fit” lid 400) against potential leakage of beverage from the cup for at least two reasons: (1) a greater degree of sealing contact (i.e., as defined by inner groove surface 722 between the inner seal point 952-1 and 952-2) between “plug fit” securement groove 844 of lid 500 and rim/brim/lip 928 of beverage cup 900; and (2) a greater securement and sealing of rim/brim/lip 928 of beverage cup 900 within “plug fit” securement groove 944 due to more of rim/brim/lip 928 of beverage cup 900 being positioned within “plug fit” securement groove 944, as well as the constricted circumferential opening or gap 956 of “plug fit” securement groove 944 which inhibits/prevents movement of rim/brim/lip 928 within “plug fit” securement groove 944. The degree of sealing, as well as the greater securement and sealing of lid 500 to rim/brim/lip 928 provided by “plug fit” securement groove 944 is especially beneficial for lids prepared from propylene polymer compositions according to embodiments of the present invention which may require additional structural stability provided by “plug fit” securement groove 944.

FIGS. 10 through 13 illustrate different configurations of molds 300 for carrying out thermoforming in Thermoforming Section 160 to provide different orientations of the sip holes 570 (as well as vent hole 578) formed in beverage sip lids 500. FIG. 10 illustrates one configuration for carrying out such thermoforming, indicated generally as 1000. Configuration 1000 shows a cut away of a portion of a beverage lid sheet, indicated generally as 1004, which is traveling or moving in the direction indicated by arrows 1008, referred to hereafter as the machine direction (MD). Double headed arrow 1012 indicates the cross-machine direction (CD) which is orthogonal to MD 1008. As shown in FIG. 10, sheet 1004 has thermoformed therein three beverage sip lids, indicated as 1016-1, 1006-2, and 1016-3, which are spaced apart in a single row. The spacing along cross-machine direction (CD) 1012 between adjacent beverage sip lids 1016-1, 1006-2, and 1016-3 is primarily determined by the amount of clearance required between molds 300 used in such thermoforming, including mechanisms (e.g., clamps, brackets, etc.) required to secure molds 300 in position for such thermoforming. For example, if the diameter of beverage sip lids 1016-1, 1006-2, and 1016-3 is in the range of from about 2.5 to about 4.3 inches (such as 3.8 inches), the distance between respective adjacent lids may be in the range of from about 0.5 to about 1.4 inches (e.g., 0.9 inches). Also, the amount of spacing in cross-machine direction (CD) 1012 beyond beverage sip lids 1016-1 and 1016-3 to the respective edges of sheet 1004 may vary and is primarily determined by the mechanism which grips, secures, etc., sheet 1004 proximate each edge thereof so that sheet 1004 may be advanced, moved, etc., in machine direction (MD) 1008.

In some embodiments of the thermoforming step according to the process of the present invention, there may be a plurality of rows (i.e., a plurality of male molds 300 used), for example, from 2 to 18, such as from 4 to 14, rows. Like the spacing between adjacent beverage sip lids 1016, the spacing between beverage sip lids in adjacent rows is determined by the amount of clearance required between molds 300 used in such thermoforming, including mechanisms (e.g., clamps, brackets, etc.) required to secure molds 300 in position for such thermoforming, and thus such spacing may be the same or similar to that between adjacent beverage sip lids 1016 in each row, as described above. In addition, in some embodiments, a different number of beverage sip lids 1016 may be formed in each row of such lids 1016 in sheet 1004, for example, from 2 to 14 per row, such as from 4 to 12 per row. The number of such beverage sip lids 1016 formed in each row may also be determined by the width of sheet 1004, as well as the spacing between adjacent lids 1016 in each row required for thermoforming with molds 300, as described above. For adjacent rows of lids 1016, lids 1016 may be arranged in a columnar configuration along machine direction (MD) 1008 wherein lids 1016 in one row are aligned or substantially aligned with lids 1016 in an adjacent row along machine direction (MD) 1008 (referred to herein as a “checkerboard” thermoforming pattern), may be arranged such that adjacent rows of lids 1016 are offset such that alternate rows of lids 1016 are aligned or substantially aligned along machine direction 1008 (referred to herein as an “offset” thermoforming pattern), etc.

As also shown in FIG. 10, sip holes 1070-1 through 1070-3, as well as vent holes 1078-1 through 1078-3 are formed in respective upper surfaces 1040-1 through 1040-3 and bowl-shaped surfaces 1054-1 through 1054-3 of lids 1016-1 through 1016-3 (e.g., by operation of Trimmer Press 168). As shown in FIG. 10, sip holes 1070-1 through 1070-3, as well as vent holes 1078-1 through 1078-3 are aligned or substantially aligned in cross-machine direction (CD) 1012, with sip holes 1070-1 through 1070-3 being oriented at the 3 o'clock position, and vent holes 1078-1 through 1078-3 being oriented at the 9 o'clock position.

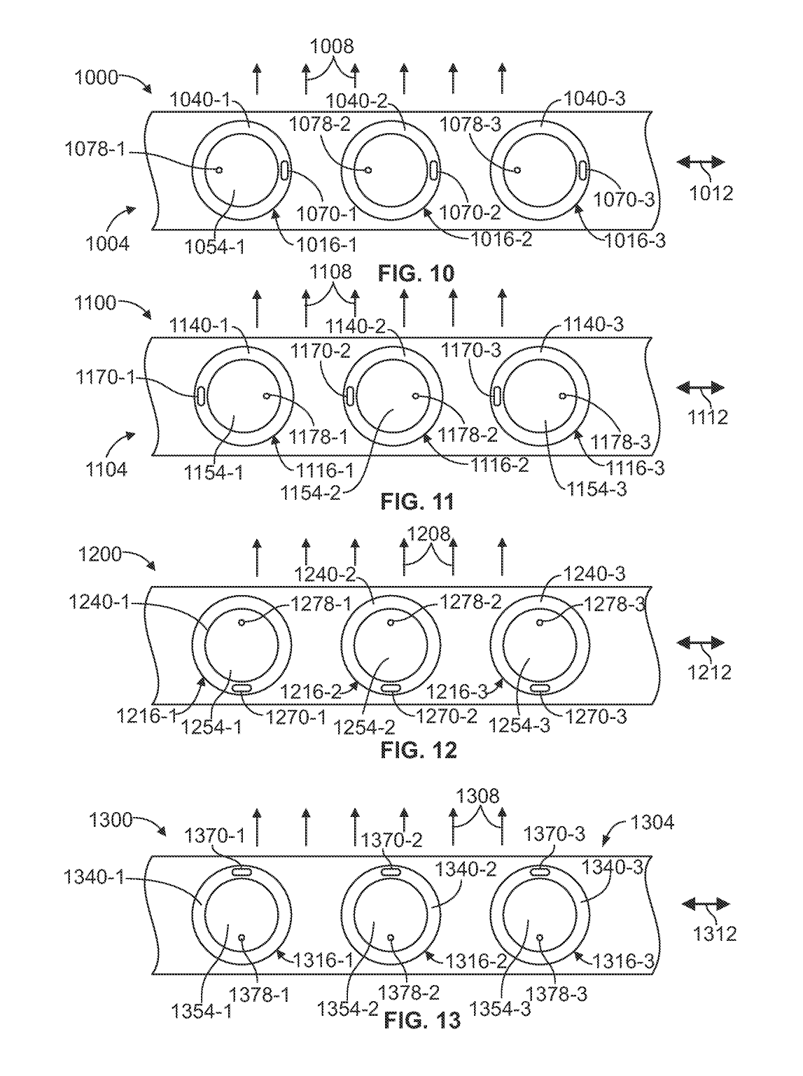

FIG. 11 illustrates another configuration for carrying out thermoforming, indicated generally as 1100. Configuration 1100 again shows a cut away of a portion of a beverage lid sheet, indicated generally as 1104, which is traveling or moving in machine direction (MD) 1108. Double headed arrow 1112 indicates the cross-machine direction (CD) which is orthogonal to machine direction (MD) 1108. As shown in FIG. 11, sheet 1104 also has thermoformed therein three beverage sip lids, indicated as 1116-1, 1106-2, and 1116-3, which are spaced apart in a single row. As also shown in FIG. 11, sip holes 1170-1 through 1170-3, as well as vent holes 1178-1 through 1178-3 are formed in respective upper surfaces 1140-1 through 1140-3 and bowl-shaped surfaces 1154-1 through 1154-3 of lids 1116-1 through 1116-3. As shown in FIG. 11, sip holes 1170-1 through 1170-3, as well as vent holes 1178-1 through 1178-3 are also aligned or substantially aligned in cross-machine direction (CD) 1112, but with sip holes 1070-1 through 1070-3 being oriented at the 9 o'clock position, and vent holes 1078-1 through 1078-3 being oriented at the 3 o'clock position.

FIG. 12 illustrates yet another configuration for carrying out thermoforming, indicated generally as 1200. Configuration 1200 again shows a cut away of a portion of a beverage lid sheet, indicated generally as 1204, which is traveling or moving in machine direction (MD) 1208. Double headed arrow 1212 indicates the cross-machine direction (CD) which is orthogonal to machine direction (MD) 1208. As shown in FIG. 12, sheet 1204 also has thermoformed therein three beverage sip lids, indicated as 1216-1, 1206-2, and 1216-3, which are spaced apart in a single row. As also shown in FIG. 12, sip holes 1170-1 through 1270-3, as well as vent holes 1278-1 through 1278-3 are formed in respective upper surfaces 1240-1 through 1240-3 and bowl-shaped surfaces 1254-1 through 1254-3 of lids 1216-1 through 1216-3. As shown in FIG. 12, sip holes 1270-1 through 1270-3, as well as vent holes 1278-1 through 1278-3 are also aligned or substantially aligned, but now in machine direction (CD) 1208, with sip holes 1270-1 through 1270-3 being oriented at the 6 o'clock position, and vent holes 1278-1 through 1278-3 being oriented at the 12 o'clock position.

FIG. 13 illustrates yet another configuration for carrying out thermoforming, indicated generally as 1300. Configuration 1300 again shows a cut away of a portion of a beverage lid sheet, indicated generally as 1304, which is traveling or moving in machine direction (MD) 1308. Double headed arrow 1312 indicates the cross-machine direction (CD) which is orthogonal to machine direction (MD) 1308. As shown in FIG. 13, sheet 1304 also has thermoformed therein three beverage sip lids, indicated as 1316-1, 1316-2, and 1216-3, which are spaced apart in a single row. As also shown in FIG. 13, sip holes 1370-1 through 1370-3, as well as vent holes 1378-1 through 1378-3 are formed in respective upper surfaces 1340-1 through 1340-3 and bowl-shaped surfaces 1354-1 through 1354-3 of lids 1316-1 through 1316-3. As shown in FIG. 13, sip holes 1370-1 through 1370-3, as well as vent holes 1378-1 through 1378-3 are also aligned or substantially aligned in machine direction (CD) 1308, but with sip holes 1370-1 through 1370-3 being oriented at the 12 o'clock position, and vent holes 1378-1 through 1378-3 being oriented at the 6 o'clock position.

It has been discovered in embodiments of beverage sip lids comprising polypropylene polymer compositions according to embodiments of the present invention that configurations 1200 and 1300 shown in FIGS. 12 and 13, wherein the sip holes (e.g., 1270-1 through 1270-3 and 1370-1 through 1370-3) are aligned or substantially aligned with machine direction (MD) 1208/1212 of advancement, travel, movement, etc., of sheet 1204/1304 during the thermoforming operation (i.e., when Thermoformable sheet 156 is passed through Thermoforming Section 160 as described above to provide thermoformed sheet 1204/1304), the drip rate of the resulting beverage sip lids 500 (e.g., after sheets 1204/1304 pass through Trimmer Press 168 which, besides removing excess Trimmed Material 176, may also form sip holes 1270-1 through 1270-3 and 1370-1 through 1370-3, as well as vent holes 1278-1 through 1278-3 and 1378-1 through 1378-3 by, for example, punching (with a punch press) lids 1216-1 through 1216-3 and 1316-1 through 1316-3 in the appropriate position/portion of those lids) significantly improves (i.e., decreases) the beverage drip rates for the resulting beverage sip lids 500 (e.g., when secured to rim/brim/lip 928 of cup 900), relative to beverage sip lids 500 prepared wherein the sip holes 570 are oriented in configuration 1000 or 1100 of FIGS. 10 and 11, wherein sip holes 1070-1 through 1070-3 and 1070-1 through 1070-3 are oriented to be aligned or substantially aligned with cross-machine direction (CD) 1012/1112. It is believed that these improvements in drip rate due to the orientation/alignment of sip holes 1270-1 through 1270-3 and 1270-1 through 1270-3 with cross-machine direction (CD) 1212/1312 is due to minimizing effects which might occur during thermoforming of sheet 1204/1304 which might adversely impact molecular orientation, crystal structure, etc., effects imparted to sheet 1204/1304 during its formation prior to thermoforming (e.g., during extrusion step 140 as described above) which impart desirable improvements in the flexural modulus (e.g., stiffness) properties of the polypropylene polymer composition present in sheet 1204/1304.

In addition, forming such beverage sip lids 1216-1 through 1216-3 and 1316-1 through 1316-3 with a “plug fit” attachment and securement mechanism (see description above with respect to FIGS. 5, 7, and 9) such as securement groove 944 also significantly improves (i.e., decreases) the beverage drip rates for the resulting beverage sip lids 500 (e.g., when secured to rim/brim/lip 928 of cup 900), relative to beverage sip lids 400, provided with an “interference fit” attachment and securement mechanism (see description above with respect to FIGS. 4, 6, and 8) such as securement groove 844. Such improvement in drip rate are imparted to beverage sip lids 500 by the “plug fit” attachment and securement mechanism because securement groove 944 provides more secure attachment to rim/brim/lip 928 of cup 900 (especially when the combination of lid 500/cup 900 are tilted from the vertical axis as will occur during sipping of the beverage through sip hole 570), as well as a greater degree of “fluid” sealing between inner seal point 952-1 and outer seal point 952-2.

Moreover, incorporating into the polypropylene polymer composition one or more β-phase polypropylene polymer crystal inducing nucleating agents during blending of the components and prior to extrusion into a thermoformable sheet (see description above with respect to Blender 128) in an amount effective to induce β-phase crystal formation in sheet 1204/1304 during extrusion thereof (see description above with respect to Extruder 136) and prior to thermoforming of sheet 1204/1304 (see description above with respect to Thermoforming Section 160) may also significantly improve (i.e., decrease) the beverage drip rates for the resulting beverage sip lids 500 (e.g., when secured to rim/brim/lip 928 of cup 900) due to desirable molecular orientation, etc., effects which are promoted in thermoformed sheet 1204/1304 by such β-phase crystal formation primarily in the machine direction (MD) 1208/1308 during, for example, extrusion to form sheet 1204/1304 prior to thermoforming.

The combination of orienting and aligning sip holes 570 with the machine direction during thermoforming of beverage sip lids 500, incorporating a “plug fit” attachment and securement mechanism, such as securement groove 944, into beverage sip lids 500, and inclusion of β-phase polypropylene polymer crystal inducing nucleating agents into the polypropylene polymer composition to induce β-phase crystal formation in sheet 1204/1304 prior to thermoforming of beverage sip lids 500 has been found to have the most significant impact on improving (decreasing) the beverage drip rate of such lids. Other factors which may impact beverage drip rate of such lids may include: the thickness of the lids; mineral filler loading in the polypropylene polymer composition; the distance (i.e., along the cross-machine direction (CD)) of a particular thermoformed lid from the machined direction (MD) centerline of the thermoformed sheet; the width of the sheet (e.g., wider width thermoformed sheets may provide beverage sip lids 500 at the edge of the sheet having higher drip rates, relative to narrower width sheets); etc.

### Drip Rate Measurement Technique

The technique for measuring drip rate for beverage sip lids is carried out as follows:

Average Lid Mass.

The average lid mass is determined by placing a stack of ten beverage sip lids on a balance. The mass (in grams) measured is then divided by 10 to determine the average lid mass of a 10 lid sample set.

Drip Test.

The drip test measures the amount of liquid (e.g., beverage such as coffee) that leaks from between the lid and the cup rim/brim/lip when the cup is tilted 90° (i.e., horizontally and parallel to the ground), and specifically targets the sideseam of the cup because the sideseam tends to create an inconsistency in lid-rim/brim/lip fit, thus providing a pathway for fluid leakage. A sample set of 12 unused lids and 12 unused cups are used in this test. On each lid is placed a small piece of scotch tape over any vent hole on the inside of the lid to seal the vent hole so that water and air cannot pass through. Each unused test cup filled to approximately 70% full with 85° C. fluid (e.g., water) and then one unused lid is secured to the rim/brim/lip of the cup with the sealed vent hole positioned over top the cup side seam, thus insuring that the positioning the unsealed sip hole is positioned (oriented) 180° opposite the sideseam, and should permit no fluid (e.g., water) to pass out through the sealed vent hole when the cup (with lid) is tilted 90°, but should permit air to pass out through the sip hole. Next, tilt the cup (with lid) 90° (i.e., horizontally and parallel to the ground) for 20 seconds with the side seam facing downward before tilting the cup/lid combination back vertically to an upright positioning, being careful to hold only hold the cup with no pressure being exerted on the lid (beyond the pressure being exerted by the fluid inside the cup). Any fluid that leaks out from in between the lid and the cup rim/brim/lip may be received (caught) in, for example, a beaker and then mass of the dripped fluid measure to determine a drip rate in units of grams/20 seconds. The test may be conducted a minimum of 12 times, i.e., with 12 unused cups and lids, in order to provide statistically acceptable data based on an averages of the test results for the 12 cups.

It should be appreciated that the embodiments of system 100, dome-shaped male mold 300, and dome-shaped beverage lid 500 illustrated in FIGS. 5, 7, and 9 are provided to illustrate the teachings of the present invention. Alterations or modifications within the skill of the art of the embodiments of system 100, dome-shaped male mold 300, and dome-shaped beverage lid 500 shown in FIGS. 3, 5, 7, and 9 are considered within the scope of the present invention, so long as these alterations or modifications operate in a same or similar manner, function, etc. For example, by appropriate modification of dome-shaped male mold 300, dome-shaped beverage lids 500 may be prepared according or similar to, for example, those disclosed in U.S. Pat. No. 8,708,181 (Buck), issued Apr. 29, 2014; U.S. Pat. No. 8,528,768 (D'Amato), issued Sep. 10, 2014; U.S. Pat. No. 7,594,584 (Durdon et al.), issued Sep. 29, 2009; U.S. Pat. No. 7,159,732 (Smith et al.), issued Jan. 9, 2007; U.S. Pat. No. 6,314,866 (Melton), issued Nov. 13, 2001; U.S. Pat. No. 5,996,837 (Freek et al.), issued Dec. 7, 1999); U.S. Pat. No. 5,624,053 (Freek et al.), issued Apr. 29, 1997; and U.S. Appln. No. 20130277380 (Koestring et al.), published Oct. 24, 2013, the entire contents and disclosures of which are hereby incorporated by reference.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An article in the form of a thermoformed fluid material container closure, the fluid material container closure comprising:
a lower container-securing portion having an inner plug fit securement groove for removably securing the fluid material container closure to an upper rim of a fluid material container; and
an upper generally dome-shaped fluid material-dispensing portion extending generally upwardly from the lower container-securing portion and having a fluid material-dispensing orifice formed therein;
wherein the fluid material container closure comprises a polypropylene polymer composition which includes from about 50 to 100% polypropylene polymer having a flexural modulus of at least about 230,000 kpsi;
wherein the fluid material container closure has a wall thickness in the range of from about 10 to about 30 mils;
wherein when the fluid material container closure is removably secured to the upper rim of the fluid material container, the removably secured fluid material container closure provides a drip rate of about 1 gram or less per 20 seconds.

2. The article of claim 1, wherein the wall thickness is in the range of from about 14 to about 24 mills.

3. The article of claim 1, wherein the polypropylene polymer has a flexural modulus in the range of from about 230,000 to about 350,000 kpsi.

4. The article of claim 3, wherein the polypropylene polymer has a flexural modulus in the range of from about 250,000 to about 300,000 kpsi.

5. The article of claim 1, wherein the polypropylene polymer composition includes one or more β-phase polypropylene polymer crystal inducing nucleating agents in an amount effective to induce β-phase crystal formation in the polypropylene polymer composition.

6. The article of claim 5, wherein the one or more β-phase polypropylene polymer crystal inducing nucleating agents are one or more of: quinacridones; the bisodium salt of o-phthalic acid; the aluminum salt of 6-quinizarin sulfonic acid; isophthalic acid; terephthalic acid; N′,N′-dicyclohexyl-2,6-naphthalene dicarboxamide; tetraoxaspiro compounds; iron oxide having a nano-scale size; potassium 1,2-hydroxystearate; magnesium benzoate; magnesium succinate; magnesium phthalate; phthalocyanine blue; or a combination of pimelic acid, azelaic acid, o-phthalic acid, terephthalic acid, or isophthalic acid with an oxide, hydroxide or an acid salt of magnesium, calcium, strontium, or barium.

7. The article of claim 6, wherein the amount of the one or more β-phase polypropylene polymer crystal inducing nucleating agents is in the range of from about 0.5 to about 10% by weight of the polypropylene polymer composition.

8. The article of claim 5, wherein the polypropylene polymer composition includes from about 83 to 100% by weight polypropylene polymer and up to about 17% by weight of a mineral filler.

9. The article of claim 8, wherein the polypropylene polymer composition includes from about 90 to 100% by weight polypropylene polymer and from 0 to about 10% by weight mineral filler.

10. An article in the form of a thermoformed reclosable beverage sip lid, the reclosable beverage sip lid comprising:
a lower generally annular cup rim-securing portion having an inner plug fit annular securement groove for removably securing the fluid material container closure to an upper rim of a beverage cup; and
an upper generally frustoconical-shaped beverage-dispensing portion extending generally upwardly from the lower portion and having a beverage-dispensing sip hole formed therein;
wherein the reclosable beverage sip lid comprises a polypropylene polymer composition which includes from about 50 to 100% polypropylene having a flexural modulus of at least about 230,000 kpsi;
wherein the reclosable beverage sip lid has a wall thickness in the range of from about 10 to about 30 mils;
wherein when the reclosable beverage sip lid is removably secured to the upper rim of the beverage cup, the reclosable beverage lid provides a drip rate of about 1 gram or less per 20 seconds.

11. The article of claim 10, wherein the wall thickness is in the range of from about 14 to about 24 mills.

12. The article of claim 11, wherein the polypropylene polymer has a flexural modulus in the range of from about 250,000 to about 300,000 kpsi.

13. The article of claim 11, wherein the polypropylene polymer composition includes one or more β-phase polypropylene polymer crystal inducing nucleating agents in an amount in the range of from about 1 to about 3% by weight of the polypropylene polymer composition, the one or more β-phase polypropylene polymer crystal inducing nucleating agents are one or more of: quinacridones; the bisodium salt of o-phthalic acid; the aluminum salt of 6-quinizarin sulfonic acid; isophthalic acid; terephthalic acid; N′,N′-dicyclohexyl-2,6-naphthalene dicarboxamide; tetraoxaspiro compounds; iron oxide having a nano-scale size; potassium 1,2-hydroxystearate; magnesium benzoate; magnesium succinate; magnesium phthalate; phthalocyanine blue; or a combination of pimelic acid, azelaic acid, o-phthalic acid, terephthalic acid, or isophthalic acid with an oxide, hydroxide or an acid salt of magnesium, calcium, strontium, or barium.

14. The article of claim 11, wherein polypropylene polymer composition includes from about 90 to 100% by weight polypropylene polymer and from 0 to about 10% by weight mineral filler.

15. A process for preparing a thermoformed fluid material container closure which comprises the following steps of:
(a) providing a thermoformable web comprising from about 50 to 100% polypropylene polymer having a flexural modulus of at least about 230,000 kpsi and having a machine direction (MD) and a cross machine direction (CD) orthogonal to the machine direction (MD) with a web width in the range of from about 20 to about 55 inches in the cross machine direction (CD);
(b) thermoforming the thermoformable web of step (a) with a fluid material closure-forming mold having a lower fluid material container-securing forming mold section which forms an inner plug fit securement groove and a generally dome-shaped upper fluid material-dispensing forming mold section extending generally upwardly from the lower mold section to provide a thermoformed fluid material container closure having a lower container-securing portion having formed therein the inner a plug fit securement groove for removably securing the fluid material container closure to an upper rim of a fluid material container and a generally dome-shaped upper fluid material-dispensing portion extending generally upwardly from the lower container-securing portion; and
(c) forming a fluid-dispensing orifice in the upper fluid material-dispensing portion which is substantially aligned with the machine direction (MD) of the thermoformable web;
wherein the thermoformed article of step (c) has:
a wall thickness in the range of from about 10 to about 30 mils;
when removably secured to the upper rim of the fluid material container, a drip rate of about 1 gram or less per 20 seconds.

16. The process of claim 15, wherein the web width in step (a) is in the range of from about 24 to about 50 inches.

17. The process of claim 15, wherein the polypropylene polymer composition of step (a) comprises polypropylene polymer having a flexural modulus in the range of from about 230,000 to about 350,000 kpsi.

18. The process of claim 17, wherein the polypropylene polymer composition of step (a) includes one or more β-phase polypropylene polymer crystal inducing nucleating agents in an amount effective to induce β-phase crystal formation in the thermoformable web of step (a).

19. The process of claim 18, wherein one or more β-phase polypropylene polymer crystal inducing nucleating agents are one or more of: quinacridones; the bisodium salt of o-phthalic acid; the aluminum salt of 6-quinizarin sulfonic acid; isophthalic acid; terephthalic acid; N′,N′-dicyclohexyl-2,6-naphthalene dicarboxamide; tetraoxaspiro compounds; iron oxide having a nano-scale size; potassium 1,2-hydroxystearate; magnesium benzoate; magnesium succinate; magnesium phthalate; phthalocyanine blue; or a combination of pimelic acid, azelaic acid, o-phthalic acid, terephthalic acid, or isophthalic acid with an oxide, hydroxide or an acid salt of magnesium, calcium, strontium, or barium, and wherein the amount of the one or more β-phase polypropylene polymer crystal inducing nucleating agents is in the range of from about 0.5 to about 10% by weight of the polypropylene polymer composition of step (a).

20. The process of claim 18, wherein the thermoformable web of step (a) is formed by extruding the polypropylene polymer composition of step (a).

21. The process of claim 15, wherein thermoforming step (b) is carried out by vacuum molding.

22. The process of claim 21, wherein thermoforming step (b) is carried out with a plurality of molds arranged in a plurality of rows spaced apart in the machine direction (MD), each of the plurality of rows comprising a plurality of male molds spaced apart in the cross-machine direction (C).

23. The process of claim 22, wherein the plurality of molds are arranged in from 2 to 18 rows, each of the plurality of rows having from 2 to 14 molds.

24. The process of claim 23, wherein the plurality of molds are arranged in from 4 to 14 rows, each of the plurality of rows having from 4 to 12 molds.

25. The process of claim 15, wherein thermoforming step (b) is carried out at a temperature in the range of from about 265° to about 450° F.

26. The process of claim 25, wherein thermoforming step (b) is carried out at a temperature in the range of from about 270° to about 380° F.

27. The process of claim 15, wherein thermoforming step (b) provides a fluid material container closure having a wall thickness in the range of from about 14 to about 24 mils.

28. The process of claim 15, wherein the mold of step (b) is a male mold.

29. A process for preparing a thermoformed reclosable beverage sip lid, which comprise the following steps of:
(a) providing a thermoformable sheet comprising from about 50 to 100% polypropylene polymer having a flexural modulus of at least about 230,000 kpsi and having a machine direction (MD) and a cross machine direction (CD) orthogonal to the machine direction (MD) with a sheet width in the range of from about 20 to about 55 inches in the cross machine direction (CD);
(b) thermoforming the thermoformable sheet of step (b) with a reclosable beverage sip lid forming mold having a generally annular lower cup rim-securing portion forming mold section which forms an inner a plug fit annular securement groove and an upper generally frustoconical-shaped beverage-dispensing portion forming mold section extending generally upwardly from the lower mold section to provide a thermoformed reclosable beverage sip lid having a lower generally annular cup rim-securing portion having formed therein the inner a plug fit annular securement groove for removably securing the beverage sip lid to an upper rim of a beverage cup and an upper generally frustoconical-shaped beverage-dispensing portion extending generally upwardly from the lower cup lip-securing portion; and
(c) forming a beverage dispensing sip hole in the upper beverage-dispensing portion thermoformed reclosable beverage lid of step (b) which is substantially aligned with the machine direction (MD) of the thermoformable sheet;
wherein the thermoformed reclosable beverage sip lid of step (c) has:
a wall thickness in the range of from about 10 to about 30 mils:
when removably secured to the upper lip of the beverage cup, a drip rate of about 1 gram or less per 20 seconds.

30. The process of claim 29, wherein the sheet width in step (a) is in the range of from about 24 to about 50 inches.

31. The process of claim 30, wherein the polypropylene polymer composition of step (a) comprises polypropylene polymer having a flexural modulus in the range of from about 230,000 to about 350,000 kpsi.

32. The process of claim 31, wherein the polypropylene polymer composition of step (a) includes one or more β-phase polypropylene polymer crystal inducing nucleating agents in an amount effective to induce β-phase crystal formation in the thermoformable web of step (a).

33. The process of claim 32, wherein one or more β-phase polypropylene polymer crystal inducing nucleating agents are one or more of: quinacridones; the bisodium salt of o-phthalic acid; the aluminum salt of 6-quinizarin sulfonic acid; isophthalic acid; terephthalic acid; N′,N′-dicyclohexyl-2,6-naphthalene dicarboxamide; tetraoxaspiro compounds; iron oxide having a nano-scale size; potassium 1,2-hydroxystearate; magnesium benzoate; magnesium succinate; magnesium phthalate; phthalocyanine blue; or a combination of pimelic acid, azelaic acid, o-phthalic acid, terephthalic acid, or isophthalic acid with an oxide, hydroxide or an acid salt of magnesium, calcium, strontium, or barium, and wherein the amount of the one or more β-phase polypropylene polymer crystal inducing nucleating agents is in the range of from about 1 to about 3% by weight of the polypropylene polymer composition of step (a).

34. The process of claim 32, wherein the thermoformable web of step (a) is formed by extruding the polypropylene polymer composition of step (a).

35. The process of claim 33, wherein thermoforming step (b) is carried out by vacuum molding.

36. The process of claim 35, wherein thermoforming step (b) is carried out with a plurality of molds arranged in a plurality of rows spaced apart in the machine direction (MD), each of the plurality of rows comprising a plurality of molds spaced apart in the cross-machine direction (C).

37. The process of claim 36 wherein the plurality of molds are arranged in from 4 to 14 rows, each of the plurality of rows having from 4 to 12 molds.

38. The process of claim 30, wherein thermoforming step (b) is carried out at a temperature in the range of from about 265° to about 450° F.

39. The process of claim 38, wherein thermoforming step (b) is carried out at a temperature in the range of from about 270° to about 380° F.

40. The process of claim 30, wherein thermoforming step (b) provides a fluid material container closure having a wall thickness in the range of from about 14 to about 24 mils.

41. The process of claim 29, wherein the mold of step (b) is a male mold.
